(19) United States
(12) Patent Application Publication
(10) Pub. No.: US 2026/0364454 A1
(43) Pub. Date: Nov. 19, 2026

(54) METHOD AND APPARATUS FOR DISPLAYING TURN-BASED COMBAT, AND DEVICE, MEDIUM, AND PRODUCT

(71) Applicant: Tencent Technology (Shenzhen) Company Limited, Shenzhen (CN)

(72) Inventors: Yang CHEN, Shenzhen (CN); Chenhuan YANG, Shenzhen (CN); Shaoyi LUO, Shenzhen (CN); Weibin HUANG, Shenzhen (CN); Yinxiang SUN, Shenzhen (CN); Wenbin ZHU, Shenzhen (CN)

(21) Appl. No.: 19/728,577

(22) Filed: Jul. 2, 2026

Related U.S. Application Data
(63) Continuation of application No. PCT/CN2025/107153, filed on Jul. 4, 2025.

(30) Foreign Application Priority Data
Aug. 19, 2024 (CN) 202411140609.9

(51) Int. Cl. A63F 13/537; A63F 13/822

(52) U.S. Cl. CPC A63F 13/537; A63F 13/822

(57) ABSTRACT

This application discloses a method for displaying turn-based combat on a screen performed by a computer device, belonging to the field of human-computer interaction. The method includes: displaying a graphical user interface including a main control virtual character exploring in a virtual world, the main control virtual character having at least one allied pet character; when a turn-based combat trigger condition is satisfied, switching the graphical user interface from a virtual world exploration state to a turn-based combat state, and controlling the allied pet character to perform turn-based combat with an enemy pet character in the turn-based combat state; and in response to a combat behavior mode selection operation, switching a current combat behavior mode among at least two combat behavior modes, and displaying a target subject located in a combat scene in different display modes.

### CROSS-REFERENCE TO RELATED APPLICATIONS

This application is a continuation application of PCT Patent Application No. PCT/CN2025/107153, entitled “METHOD AND APPARATUS FOR DISPLAYING TURN-BASED COMBAT, AND DEVICE, MEDIUM, AND PRODUCT” filed on Jul. 4, 2025, which claims priority to Chinese Patent Application No. 202411140609.9, entitled “METHOD AND APPARATUS FOR DISPLAYING TURN-BASED COMBAT, AND DEVICE, MEDIUM, AND PRODUCT” and filed on Aug. 19, 2024, both of which are incorporated herein by reference in their entirety.

### FIELD OF THE TECHNOLOGY

Embodiments of this application relate to the field of human-computer interaction, and in particular, to a method and apparatus for displaying turn-based combat, and a device, a medium, and a product.

### BACKGROUND OF THE DISCLOSURE

In turn-based games, in a non-combat scene, a main control virtual character moves in a world map. In a combat scene, the main control virtual character controls a captured pet virtual character in a combat map to perform turn-based combat with an enemy unit (a monster or a pet virtual character captured by another character).

In a typical turn-based game, at the beginning of combat, a server calculates and sets a fixed perspective. The fixed perspective is to be able to cover a key region in the combat scene. A client presents the fixed perspective to a player. The player controls, via the main control virtual character, a pet virtual character to perform combat at the fixed perspective.

However, since a location of the combat scene is randomly generated in the world map, a subject may appear at a non-visual focus position in a current virtual world picture. As a result, there is a problem that the subject is not prominent, and the player's sight cannot immediately capture important information in the current virtual world picture.

### SUMMARY

This application provides a method and apparatus for displaying turn-based combat, and a device, a medium, and a product. The technical solutions are as follows.

According to one aspect of this application, a method for displaying turn-based combat on a screen is performed by a computer device, and the method includes:
displaying a graphical user interface including a main control virtual character exploring in a virtual world, the main control virtual character having at least one allied pet character;
when a turn-based combat trigger condition is satisfied, switching the graphical user interface from a virtual world exploration state to a turn-based combat state, and controlling the allied pet character to perform turn-based combat with an enemy pet character in the turn-based combat state; and
in response to a combat behavior mode selection operation, switching a current combat behavior mode among at least two combat behavior modes, and displaying a target subject located in a combat scene in different display modes, where the target subject includes at least one of the main control virtual character, the allied pet character, and the enemy pet character.

According to another aspect of this application, a computer device is provided. The computer device includes a processor and a memory. The memory has at least one computer program stored therein, and the at least one computer program, when loaded and executed by the processor, causing the computer device to implement the method for displaying turn-based combat on a screen according to the aspects described above.

According to another aspect of this application, a non-transitory computer storage medium is provided. The computer-readable storage medium has at least one computer program stored therein, and the at least one computer program, when loaded and executed by a processor of a computer device, causing the computer device to implement the method for displaying turn-based combat on a screen according to the aspects described above.

According to another aspect of this application, a computer program product is provided. The computer program product includes a computer program, and the computer program is stored in a computer-readable storage medium. The computer program is read and executed by a processor of a computer device from the computer-readable storage medium, causing the computer device to execute the method for displaying turn-based combat according to the aspects described above.

The technical solutions provided in the embodiments of this application have at least the following beneficial effects:

In a turn-based game, by controlling the main control virtual character located in the virtual world to explore in the virtual world, after the turn-based combat trigger condition is satisfied, the virtual world exploration state is switched to the turn-based combat state, a world scene is switched to the combat scene (also referred to as a turn-based combat scene), and the allied pet character and the enemy pet character are controlled to perform turn-based combat. In the combat scene, the main control virtual character may enter different combat behavior modes. For different combat behavior modes in the combat scene, corresponding display modes of a virtual world picture are different. Each combat behavior mode has a corresponding display mode, and the target subject located in the combat scene may be displayed according to different display modes. The method of determining the display mode according to different combat behavior modes may prominently display the target subject in a current virtual world picture, helping a player focus on information with a higher current importance level.

In other words, during turn-based combat, by switching the current combat behavior mode in response to a selection operation on different combat behavior modes, and displaying the target subject located in the combat scene in the display mode corresponding to the current combat behavior mode, a display effect of the target subject may be optimized, facilitating the player to acquire game-related information associated with the target subject.

### BRIEF DESCRIPTION OF THE DRAWINGS

To describe the technical solutions more clearly in the embodiments of this application, the following will briefly introduce the drawings needed in the description of the embodiments. The drawings in the following description are only some embodiments of this application. Those of ordinary skill in the art may obtain other drawings from these drawings without contributing any inventive labor.

FIG. 1 shows a schematic diagram of a virtual world according to an embodiment.

FIG. 2 shows a schematic diagram of a virtual world according to an embodiment.

FIG. 3 shows a structural block diagram of a computer system according to an embodiment.

FIG. 4 shows a schematic diagram displayed from an observation perspective in related art according to an embodiment.

FIG. 5 shows a schematic diagram displayed from an observation perspective in related art according to an embodiment.

FIG. 6 shows a schematic diagram of a method for displaying turn-based combat according to an embodiment.

FIG. 7 shows a flowchart of a method for displaying turn-based combat according to an embodiment.

FIG. 8 shows a flowchart of a method for displaying turn-based combat according to an embodiment.

FIG. 9 shows a schematic diagram of a method for displaying turn-based combat according to an embodiment.

FIG. 10 shows a schematic diagram of a method for displaying turn-based combat according to an embodiment.

FIG. 11 shows a schematic diagram of a method for displaying turn-based combat according to an embodiment.

FIG. 12 shows a schematic diagram of a method for displaying turn-based combat according to an embodiment.

FIG. 13 shows a schematic diagram of a method for displaying turn-based combat according to an embodiment.

FIG. 14 shows a schematic diagram of a method for displaying turn-based combat according to an embodiment.

FIG. 15 shows a schematic diagram of a method for displaying turn-based combat according to an embodiment.

FIG. 16 shows a schematic diagram of a method for displaying turn-based combat according to an embodiment.

FIG. 17 shows a flowchart of a method for displaying turn-based combat according to an embodiment.

FIG. 18 shows a schematic diagram of a method for displaying turn-based combat according to an embodiment.

FIG. 19 shows a schematic diagram of a method for displaying turn-based combat according to an embodiment.

FIG. 20 shows a schematic diagram of a method for displaying turn-based combat according to an embodiment.

FIG. 21 shows a schematic diagram of a method for displaying turn-based combat according to an embodiment.

FIG. 22 shows a flowchart of a method for displaying turn-based combat according to an embodiment.

FIG. 23 is a structural block diagram of an apparatus for displaying turn-based combat according to an embodiment of this application.

FIG. 24 is a schematic structural diagram of a computer device according to an embodiment of this application.

### DESCRIPTION OF EMBODIMENTS

To make the objectives, technical solutions, and advantages of this application clearer, the following further describes the implementations of this application in detail with reference to the accompanying drawings.

Exemplary embodiments will be described in detail herein, and examples of the embodiments are shown in the accompanying drawings. When the following description involves the accompanying drawings, unless otherwise denoted, the same numerals in different accompanying drawings denote the same or similar elements. Implementations described in the following embodiments do not represent all implementations consistent with this application. Instead, the implementations are merely examples of apparatuses and methods that are described in detail in the appended claims and that are consistent with some aspects of this application.

Terms used in this application are merely intended to describe the specific embodiments but are not intended to limit this application. The singular forms of “a/an”, “the”, and “this” used in this application and the appended claims are intended to include the plural forms as well, unless the context clearly indicates otherwise. The term “and/or” used herein indicates and includes any or all combinations of one or more associated listed items.

Although terms “first”, “second”, and the like may be used in this application to describe various pieces of information, these pieces of information are not limited by the terms. These terms are merely used for differentiating the same type of information. For example, without departing from the scope of this application, a first parameter may also be referred to as a second parameter. Similarly, a second parameter may also be referred to as a first parameter. Depending on the context, for example, a word “if” used herein may be explained as “while . . . ” or “when . . . ” or “in response to determining”.

This application may display a prompt interface, a pop-up window, or output voice prompt information before collecting user-related data and during the process of collecting user-related data. The prompt interface, pop-up window, or voice prompt information is configured for prompting a user that his/her related data is currently being collected, such that this application starts to perform related operations of acquiring the user-related data only after obtaining a confirmation operation from the user on the prompt interface or pop-up window. Otherwise (i.e., when the confirmation operation from the user on the prompt interface or pop-up window is not obtained), the related operations of acquiring the user-related data are terminated, that is, the user-related data is not acquired. In other words, all user data collected in this application are collected with the consent and authorization of the user, and the collection, use, and processing of the related user data need to comply with relevant laws, regulations, and standards in relevant countries and regions.

First, related terms involved in this application will be introduced.
Virtual world: it refers to a virtual world displayed (or provided) when an application program runs on a terminal. The virtual world may be a simulated world of a real world, or may be a semi-simulation and semi-fiction three-dimensional world, and may further be a purely fictional three-dimensional world. The virtual world may be any one of a two-dimensional virtual world, a 2.5-dimensional virtual world, and a three-dimensional virtual world, which is not limited in this application. In some embodiments, the virtual world is further configured for a virtual world battle between at least two virtual characters, and there are virtual resources available for use by the at least two virtual characters in the virtual world.
Main control virtual character: it refers to a movable object played by a player in a virtual world. The main control virtual character may be a virtual person, a virtual animal, or an animation character, for example, a person or an animal displayed in a three-dimensional virtual world. In some embodiments, the main control virtual character is a three-dimensional stereoscopic model created based on a skeleton animation technology. Each main control virtual character has a shape and a volume in the three-dimensional virtual world and occupies a part of the space in the three-dimensional virtual world.

In some embodiments, the main control virtual character is a virtual character that plays a role of an attacking side in a game. In some embodiments, the main control virtual character may be a virtual character controlled by a player, or the main control virtual character may be a virtual character controlled by Artificial Intelligence (AI). The embodiments of this application are described by using an example in which the main control virtual character is a virtual character controlled by a player.
Pet virtual character: it refers to a movable object in a virtual world. The pet virtual character may be a virtual creature, a virtual animal, a virtual monster, a virtual elf, a virtual pet, or the like, for example, a movable object displayed in an animal form or other forms in a three-dimensional virtual world. The pet virtual character may be subjected to at least one of interaction operations such as capturing, raising, and upgrading performed by the main control virtual character. The pet virtual character may assist the main control virtual character in performing at least one of interaction operations such as collecting, fighting, and changing a land plot.

In some embodiments, the pet virtual character includes an allied pet character and an enemy pet character.

The allied pet character is a pet character that has been successfully captured by the main control virtual character. The main control virtual character is a virtual character controlled by a current player. An allied pet character that has been successfully captured may be controlled by the current player; or the current player may specify a combat policy, and then the allied pet character is controlled by AI based on the combat policy, which is not limited in this application.

The enemy pet character is a pet virtual character that does not belong to a camp of the main control virtual character. The enemy pet character includes at least one of: a monster controlled by a non-player character (NPC), a wild monster, a monster controlled by AI, a pet character that has not been successfully captured, and a pet character captured by a virtual character controlled by another player.
Spring arm component: in a game engine, a spring arm component is a component for connecting an observed target and a virtual camera model. A terminal device displays a virtual world through a virtual world picture. The virtual world picture is a picture for observing the virtual world from an observation perspective corresponding to a virtual camera model. For example, an observed target is the main control virtual character, when a third-person perspective is used for observing the virtual world, the virtual camera model may be located behind the main control virtual character and bound to the main control virtual character via the spring arm component.

In the embodiments of this application, the spring arm component is a component for a virtual reference axis and the virtual camera model. In some embodiments, the spring arm component takes the virtual reference axis as a start point and the virtual camera model as an end point. The virtual reference axis is configured for indicating a position of a target subject in a combat scene, and is a virtual axis that connects the target subject in a current combat behavior mode. The spring arm component allows the virtual camera model to dynamically move and rotate around the target subject while maintaining certain distance. The spring arm component may automatically contract or extend to dynamically adjust a length as needed, so as to prevent the virtual camera model from being shielded by an object in the virtual world, ensuring smoothness of a field of view of a player. The spring arm component may be configured with various parameters, such as length, rotation limit, and collision detection, so as to adapt to different game design requirements.
Turn-based Role-Playing Game (RPG): it refers to a game type in which a player plays a virtual character in a realistic world or a virtual world. The turn-based RPG offers two types of maps: a world map and a combat map. In a non-combat scene, the virtual character moves in the world map, for example, playing, capturing a pet virtual character, collecting a treasure chest, collecting a virtual prop, or the like. In a combat scene, the virtual character controls, in the combat map, a captured pet virtual character (a first pet virtual character) to perform turn-based combat with an enemy unit (a second pet virtual character), for example, the enemy unit is a non-player character (NPC) in the game, a monster controlled by AI, or a pet virtual character captured by another character, or the like.
World map: the world map includes multiple land plots. Each land plot is a polygonal land plot. The polygonal land plot may be any one of square, rectangle, and hexagon. For example, each land plot is a 50 cm*50 cm square. Each land plot has an own surface attribute. The surface attribute includes grass, stone, water, and the like. In addition, the multiple land plots included in the world map may be of the same type, or a combination of multiple different types.

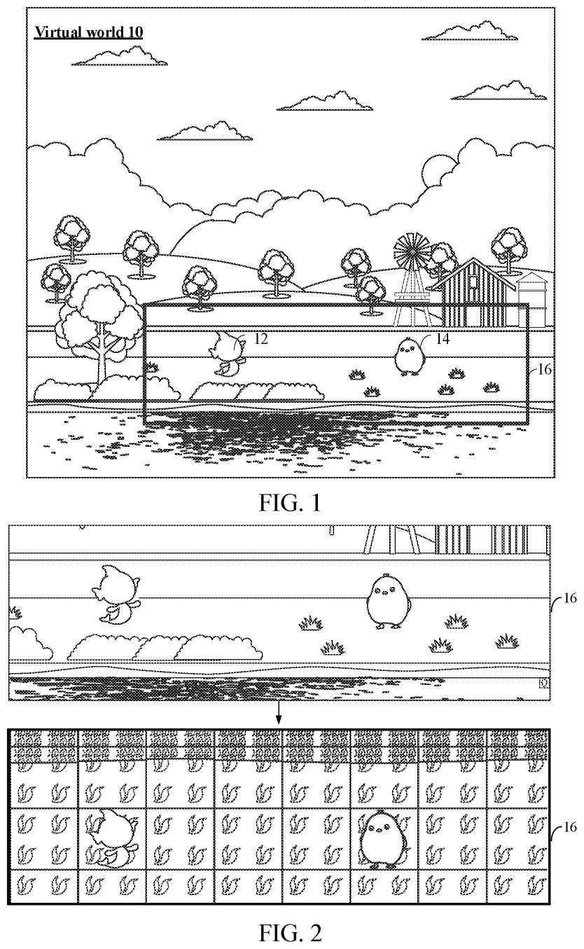

In some embodiments, the time of an open world game is controlled by a Time of Day (TOD, 24 hours) system. Under the control of the TOD system, the world map will have time-related factors such as weather, day and night, seasons, and festivals.
Combat map: in some embodiments, a combat map is a part of the world map. When entering turn-based combat, the combat map in the combat scene and the world map in the world scene use the same map data. In some embodiments, when not entering turn-based combat, a world server loads map data of the world map. When entering turn-based combat, a combat server loads data of a partial map of the world map, such that the combat map and the partial map share the same map data. Referring to FIG. 1 and FIG. 2, in a virtual world 10, when a first pet virtual character 12 encounters a second pet virtual character 14 at certain location in the world map to enter combat, one or more land plots within certain range centered on a reference position determined by the first pet virtual character 12 in the world map are determined as a combat map 16. The reference position is a position where the first pet virtual character 12 is located, or a suitable combat position closest to the first pet virtual character 12. In some embodiments, the combat map 16 includes all land plots within a circular range having a predetermined length as a radius and centered on the reference position. In some embodiments, the combat map 16 includes all land plots within a rectangular range having a predetermined length and a predetermined width and centered on the reference position.
World scene: it refers to a scene corresponding to a world map. When a world scene is displayed in a user interface, one or more land plots in the world map may be displayed in the user interface. For example, one or more land plots where a main control virtual character or a pet virtual character is currently located in the world map are displayed in the user interface, along with some interface elements related to the displayed land plots, the main control virtual character, the pet virtual character, and the like.
Combat scene: it refers to a scene corresponding to a combat map. when a combat scene is displayed in a user interface, the combat map may be displayed in the user interface. For example, all or part of land plots included in the combat map may be displayed. For example, one or more land plots where a main control virtual character or a pet virtual character is currently located in the combat map are displayed in the user interface, along with some interface elements related to the displayed land plots, the main control virtual character, the pet virtual character, and the like. In some embodiments, the world scene and the combat scene are switchable, for example, switched from the world scene to the combat scene, or switched from the combat scene to the world scene. In some embodiments, the world scene is also referred to as a non-combat scene, and the turn-based combat scene is also referred to as a combat scene.

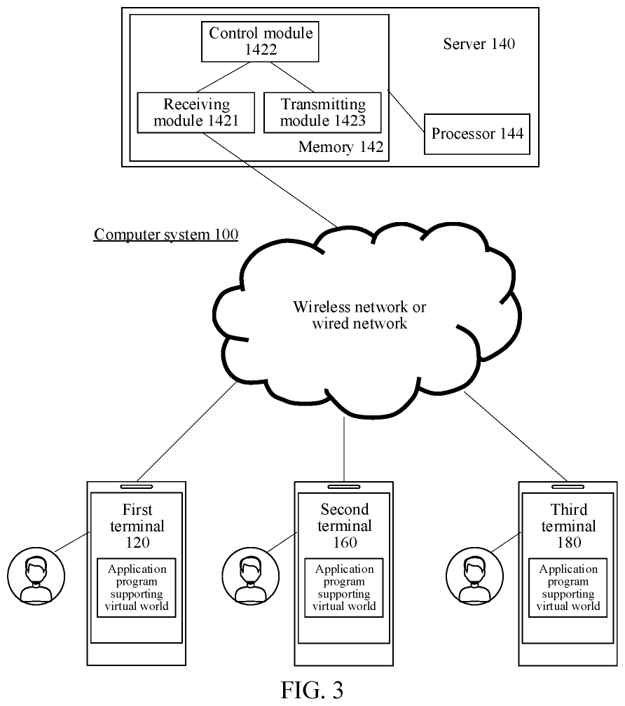

FIG. 3 shows a structural block diagram of a computer system according to an embodiment of this application. The computer system 100 includes: a first terminal 120, a server 140, a second terminal 160, and a third terminal 180.

The first terminal 120 is installed with and runs a client of an application program that supports a virtual world. The application program may be any one of a three-dimensional map program, a virtual reality (VR) application program, an augmented reality (AR) program, an RPG program, a turn-based game program, and a turn-based RPG program. The first terminal 120 is a terminal used by a first user. The first user uses the first terminal 120 to control a first virtual character located in the virtual world to perform activities. The first virtual character serves as a main control virtual character. The activities include, but are not limited to, at least one of: adjusting a body posture, walking, running, jumping, riding, driving, aiming, picking up, capturing an enemy pet character, controlling an allied pet character, raising the allied pet character, using the allied pet character for picking, using the allied pet character for combat, using a throwing prop, and attacking another virtual character. Exemplarily, the first virtual character is a first virtual person, such as a simulated person object or an animation person object. Exemplarily, the first user controls the first virtual character to perform activities through user interface (UI) controls on a virtual world picture, and the first user controls the first virtual character to throw the allied pet character through the UI controls on the virtual world picture.

The first terminal 120 is connected to the server 140 through a wireless or wired network.

The server 140 includes at least one of one server, multiple servers, a cloud computing platform, and a virtualization center. Exemplarily, the server 140 includes a processor 144 and a memory 142. The memory 142 further includes a receiving module 1421, a control module 1422, and a transmitting module 1423. The receiving module 1421 is configured to receive a request transmitted by a client, for example, a request for viewing a position of an enemy virtual character. The control module 1422 is configured to control rendering of the virtual world picture. The transmitting module 1423 is configured to transmit a response to the client, for example, transmit a position of a third virtual character to the client. The server 140 is configured to provide background services for the application program that supports the three-dimensional virtual world. In some embodiments, the server 140 undertakes primary computing tasks, and the first terminal 120, the second terminal 160, and the third terminal 180 undertake secondary computing tasks; or, the server 140 undertakes secondary computing tasks, and the first terminal 120, the second terminal 160, and the third terminal 180 undertake primary computing tasks; or, a distributed computing architecture is adopted among the server 140, the first terminal 120, the second terminal 160, and the third terminal 180 to perform collaborative computing.

The second terminal 160 is installed with and runs a client of an application that supports a virtual world. The second terminal 160 is a terminal used by a second user. The second user uses the second terminal 160 to control a second virtual character located in the virtual world to perform activities. The second virtual character also serves as a main control virtual character. The third terminal 180 is installed with and runs an application that supports a virtual world. The third terminal 180 is a terminal used by a third user. The third user uses the third terminal 180 to control a third virtual character in the virtual world to perform activities.

In some embodiments, the first virtual character, the second virtual character, and the third virtual character are in the same virtual world. The first virtual character and the second virtual character belong to different camps, and the second virtual character and the third virtual character belong to the same camp.

In some embodiments, the application programs installed on the first terminal 120, the second terminal 160, and the third terminal 180 are the same, or the application programs installed on the three terminals are the same type of application programs on different operating system platforms (Android or iOS). The first terminal 120 may refer to one of multiple terminals, the second terminal 160 may refer to one of multiple terminals, and the third terminal 180 may refer to one of multiple terminals. This embodiment only uses the first terminal 120, the second terminal 160, and the third terminal 180 for illustration. Device types of the first terminal 120, the second terminal 160, and the third terminal 180 are the same or different. The device types include at least one of: a smart phone, a smart watch, a smart television, a tablet computer, an e-book reader, a Moving Picture Experts Group Audio Layer III (MP3) player, a Moving Picture Experts Group Audio Layer IV (MP4) player, a laptop portable computer, and a desktop computer. The following embodiments are described by using an example in which the terminal includes a smart phone.

A person skilled in the art will appreciate that the number of the above terminals may be larger or smaller. For example, the number of the above terminals may be only one, or may be dozens or hundreds, or even more. The embodiments of this application do not limit the number and device types of the terminals.

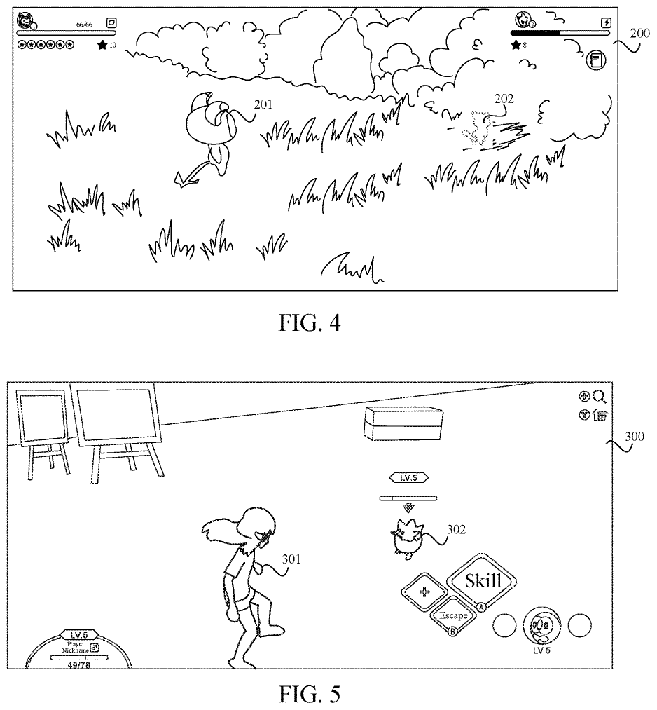

FIG. 4 shows a schematic diagram displayed from an observation perspective in related art according to an embodiment of this application. In the related art, when displaying a world scene, a virtual camera model captures the world scene from a perspective of a main control virtual character, for example, using a first-person perspective or a third-person perspective to capture the world scene. Exemplarily, as shown in FIG. 4, in a virtual world picture 200 of the world scene, an allied pet character 201 and an enemy pet character 202 are displayed in the virtual world picture 200. The allied pet character 201 is located at a focus position of a visual region, and the enemy pet character 202 is located at a non-focus position of the visual region. However, since a location of a combat scene is randomly generated in the world map (a turn-based combat trigger condition is satisfied), when entering turn-based combat in this case, the server loads data of a partial map of the world map, such that the combat map and the partial map share the same map data. When displaying the combat scene, the enemy pet character 202 is still located at the non-focus position of the visual region, resulting in a problem that a subject is not prominent.

In the related art, to solve the problem that the subject is not prominent, a player may control a virtual character to move freely. As shown in FIG. 5, after entering turn-based combat, a virtual world picture 300 is displayed. In the virtual world picture 300, the player may control and move a main control virtual character 301 and an enemy pet character 302 to be both located at a middle position of the combat picture, so that both the main control virtual character 301 and the enemy pet character 302 are located at a focus position of a visual region. However, such a manner of manual control and movement by the player reduces the sense of immersion of the combat.

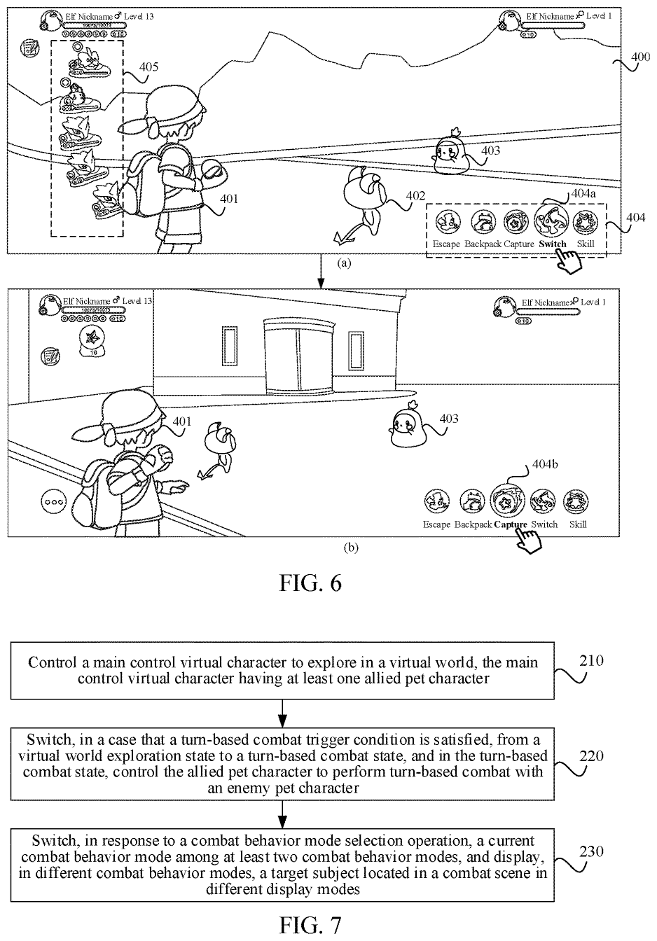

Based on this, an embodiment of this application provides a method for displaying turn-based combat. FIG. 6 shows a schematic diagram of a method for displaying turn-based combat according to an embodiment of this application. The method is described by using an example in which the method is executed by a client of an application program that supports a virtual world.

Exemplarily, with reference to FIG. 6, a main control virtual character 401 located in a virtual world 400 is controlled. The main control virtual character 401 is configured to explore in the virtual world 400, and to control an allied pet character 402 and an enemy pet character 403 to perform turn-based combat. The main control virtual character 401 is a virtual character controlled by a player. The allied pet character 402 is a virtual character subordinate to the main control virtual character 401. The enemy pet character is a virtual character that does not belong to a camp of the main control virtual character. For example, the enemy pet character 403 is a virtual character hostile to the main control virtual character 401.

In some embodiments, a mode control list 404 is displayed on a virtual world picture. The mode control list 404 displays at least one mode control. Exemplarily, as shown in part (a) of FIG. 6, the mode controls in the mode control list 404 include a “skill control”, a “switch control”, a “capture control”, a “backpack control”, and an “escape control”. In some embodiments, each mode control corresponds to a combat behavior mode, and the mode control is configured to trigger the main control virtual character 401 to enter the combat behavior mode. For example, the combat behavior mode corresponding to the “skill control” is a combat skill selection mode; the combat behavior mode corresponding to the “switch control” is an allied pet character selection mode; the combat behavior mode corresponding to the “capture control” is an enemy pet character capture mode; the combat behavior mode corresponding to the “backpack control” is a prop using mode; and the combat behavior mode corresponding to the “escape control” is an escape mode.

In some embodiments, a terminal device displays the virtual world through the virtual world picture. The virtual world picture is a picture for observing the virtual world from an observation perspective corresponding to a virtual camera model. When the main control virtual character 401 is in different combat behavior modes, the terminal device displays a target subject located in a combat scene in different display modes. In some embodiments, the display modes include at least one of an observation perspective-based display mode and a control layout-based display mode.

In some embodiments, the display mode is an observation perspective-based display mode. When the main control virtual character 401 is in different combat behavior modes, the terminal device displays the target subject located in the combat scene based on an observation perspective corresponding to a current combat behavior mode. The target subject includes, but is not limited to, at least one of the main control virtual character 401, the allied pet character 402, and the enemy pet character 403. In some embodiments, for different combat behavior modes in the combat scene, corresponding observation perspectives of the virtual world picture are different, and each combat behavior mode has an observation perspective matched therewith. In some embodiments, in different combat behavior modes, the displayed target subjects are different, that is, visual focuses displayed in the virtual world picture are different.

Exemplarily, as shown in part (a) of FIG. 6, in response to a selection operation on a switch control 404a, the terminal device determines that the current combat behavior mode is the allied pet character selection mode. In the allied pet character selection mode, the target subjects located in the combat scene are determined to be the main control virtual character 401 and the allied pet character 402. In some embodiments, in the allied pet character selection mode, the target subjects located in the combat scene are prominently displayed based on an observation perspective corresponding to the allied pet character selection mode. In this case, a selection operation of the main control virtual character 401 on the allied pet character 402 is highlighted. In some embodiments, a current observation perspective is determined by taking the main control virtual character 401 as a primary priority object and the allied pet character 402 as a secondary priority object. For example, the current observation perspective is located at a position slightly to the left of the center between the main control virtual character 401 and the allied pet character 402 (highlighting the selection operation of the main control virtual character 401 on the allied pet character 402). That is, in this case, the virtual camera model is located at a position slightly to the left of the center between the main control virtual character 401 and the allied pet character 402.

Exemplarily, as shown in part (b) of FIG. 6, in response to a selection operation on a capture control 404b, the terminal device determines that the current combat behavior mode is the enemy pet character capture mode. In the enemy pet character capture mode, the target subjects located in the combat scene are determined to be the main control virtual character 401 and the enemy pet character 403. In some embodiments, in the enemy pet character capture mode, a capture operation of the main control virtual character 401 on the enemy pet character 403 is highlighted. In this case, the current observation perspective is determined by taking both the main control virtual character 401 and the enemy pet character 403 as primary priority objects. For example, the current observation perspective is located at a middle position between the main control virtual character 401 and the enemy pet character 403. That is, in this case, the virtual camera model is located at the middle position between the main control virtual character 401 and the enemy pet character 403.

In some embodiments, the display mode is a control layout-based display mode. When the main control virtual character 401 is in different combat behavior modes, the terminal device displays the target subject located in the combat scene in a control layout corresponding to the current combat behavior mode. In some embodiments, for different combat behavior modes in the combat scene, corresponding control layouts of the virtual world picture are different.

Exemplarily, as shown in part (a) of FIG. 6, when the current combat behavior mode is the allied pet character selection mode, the terminal device prominently displays the target subjects located in the combat scene based on a control layout corresponding to the allied pet character selection mode. In this case, the target subjects include the main control virtual character 401 and the allied pet character 402, and a selection operation of the main control virtual character 401 on the allied pet character 402 is highlighted. In the allied pet character selection mode, at least two interface controls 405 are displayed as a pet list control. The pet list control highlights the selection operation of the main control virtual character 401 on the allied pet character 402. In this case, the at least two interface controls 405 are displayed in a surrounding manner around the main control virtual character 401. Display positions of the at least two interface controls 405 are related to the main control virtual character 401. The main control virtual character 401 is located at a left position on the virtual world picture, and the at least two interface controls 405 are arranged in a surrounding manner around the left side of the main control virtual character 401. This display mode may occupy as little as possible the middle position of the virtual world picture, ensuring the simplicity of an interface and enhancing the immersive experience of the animation.

FIG. 7 is a flowchart of a method for displaying turn-based combat according to an embodiment of this application. The method is described by using an example in which the method is applied to the first terminal 120 and/or the second terminal 160 and/or the third terminal 180 shown in FIG. 3, or a client that supports a virtual world and is installed on the first terminal 120 and/or the second terminal 160 and/or the third terminal 180. The method at least includes operation 210, operation 220, and operation 230.
Operation 210: Control a main control virtual character to explore in a virtual world, the main control virtual character having at least one allied pet character.

In some embodiments, a client that supports a virtual environment runs in a terminal device. A scene picture of the main control virtual character is displayed on a game interface of the client. The main control virtual character is a virtual character that plays a role of an attacking side in the game. In some embodiments, the main control virtual character may be a virtual character controlled by a player, or the main control virtual character may be a virtual character controlled by AI. The embodiments of this application are described by using an example in which the main control virtual character is a virtual character controlled by a player.

In some embodiments, the player may control the main control virtual character to explore in the virtual world. For example, the main control virtual character performs activities such as walking, running, jumping, collecting resources, discovering new locations, completing tasks, solving puzzles, capturing wild monsters, raising the allied pet character, using the allied pet character for picking, using the allied pet character for combat, using a throwing type prop, and attacking other virtual characters in the virtual world.

In some embodiments, the main control virtual character has at least one allied pet character. The allied pet character is a pet character that has been successfully captured by the main control virtual character. The main control virtual character is a virtual character controlled by a current player. An allied pet character that has been successfully captured may be controlled by the current player; or the current player may specify a combat policy, and then the allied pet character is controlled by AI based on the combat policy, which is not limited in this application.
Operation 220: Switch, when a turn-based combat trigger condition is satisfied, from a virtual world exploration state to a turn-based combat state, and in the turn-based combat state, control the allied pet character to perform turn-based combat with an enemy pet character.

The enemy pet character is a pet virtual character that does not belong to a camp of the main control virtual character. The enemy pet character includes at least one of: a monster controlled by an NPC, a wild monster, a monster controlled by AI, a pet character that has not been successfully captured, and a pet character captured by a virtual character controlled by another player. The embodiments of this application do not limit the type of the enemy pet character. For example, the enemy pet character is described as a monster controlled by AI.

In some embodiments, the main control virtual character, along with the allied pet character, explores in the world scene. After the turn-based combat trigger condition is satisfied, the terminal device switches a game state from the virtual world exploration state to the turn-based combat state. In some embodiments, a current scene picture is switched from the world scene to a combat scene. In the combat scene, the main control virtual character controls the allied pet character to perform turn-based combat with the enemy pet character.

In some embodiments, the turn-based combat trigger condition is a condition for triggering switching between the virtual world exploration state and the turn-based combat state. Alternatively, the turn-based combat trigger condition is a condition for triggering the allied pet character and the enemy pet character to perform turn-based combat. The virtual world exploration state refers to a state in which the main control virtual character freely explores and interacts in the virtual world. The turn-based combat state refers to a state in which the main control virtual character controls the allied pet character to perform turn-based combat with the enemy pet character.

In some embodiments, the turn-based combat refers to a combat mode in which two opposing sides alternately perform attacks, defenses, or attribute enhancements according to a turn order. For example, the two opposing sides are the allied pet character and the enemy pet character, respectively. Different from a real-time combat mode, the turn-based combat places more emphasis on the order in the combat process. In some embodiments, a complete turn in the turn-based combat refers to the allied pet character and the enemy pet character alternately complete performing active operations of attack, defense, or attribute enhancement.

Exemplarily, a complete turn in the turn-based combat may refer to that the allied pet character and the enemy pet character each attacks the other once; or, a complete turn may refer to that the allied pet character continuously launches attacks on the enemy pet character; or, a complete turn may refer to that the allied pet character and the enemy pet character alternately launches attacks until one of the opposing sides fails or escapes.

In an embodiment, the turn-based combat trigger condition is manually triggered by the current player. For example, after the current player controls the main control virtual character to aim at an uncaptured enemy pet character with a container prop, the player throws the container prop at the enemy pet character, thereby triggering the turn-based combat trigger condition.

In another embodiment, the turn-based combat trigger condition is manually triggered by another player. For example, one player (an opposing player) may initiate a challenge to another player (a current player), thereby triggering the turn-based combat trigger condition.

In another embodiment, the turn-based combat trigger condition is triggered by the terminal device or a server. For example, after the main control virtual character approaches a wild monster, a distance between the main control virtual character and the wild monster becomes less than a threshold, and the terminal device or the server automatically triggers the turn-based combat trigger condition based on an AI control logic. This application does not limit a triggering manner of the turn-based combat trigger condition.

In some embodiments, the turn-based combat trigger condition includes, but is not limited to, at least one of the following:
the main control virtual character and/or the allied pet character meets the enemy pet character in a world map;
a distance between the main control virtual character and/or the allied pet character and the enemy pet character is less than a first threshold;
the main control virtual character throws a container prop at the enemy pet character;
the main control virtual character uses magic on the enemy pet character;
the main control virtual character performs an interaction operation on the enemy pet character, for example, initiating combat, feeding, or petting;
the allied pet character meets the enemy pet character, where at least one of them is in a combat-ready state;
the allied pet character meets the enemy pet character, where at least one of them has a combat attribute;
the allied pet character meets the enemy pet character, and attributes of the two are mutually countering;
the main control virtual character or the allied pet character is ambushed by the enemy pet character; and
at least one of a first main control virtual character and a second main control virtual character confirms to perform a battle.

The first main control virtual character is a main control virtual character controlled by a first player (for example, a current player), and the second main control virtual character may be a main control virtual character controlled by a second player (for example, an opposing player) or may be an NPC set by the game.

The above are only exemplary descriptions and do not constitute a limitation on the turn-based combat trigger condition.

In some embodiments, the turn-based combat trigger condition is actively triggered. After a detection condition is satisfied, turn-based combat is triggered.

In some embodiments, the detection condition includes at least one of the following:
camps of the main control virtual character and/or the allied pet character and the enemy pet character are hostile camps;
positions of the main control virtual character and/or the allied pet character and the enemy pet character in the world scene are in a combat-allowed region; and
a time of the allied pet character and the enemy pet character in the world scene is a combat-allowed time.

The above are only exemplary descriptions and do not constitute a limitation on the detection condition.
Operation 230: Switch, in response to a combat behavior mode selection operation, a current combat behavior mode among at least two combat behavior modes, and display, in different combat behavior modes, a target subject located in a combat scene in different display modes.

In some embodiments, after the turn-based combat trigger condition is satisfied, the terminal device controls the allied pet character and the enemy pet character to perform turn-based combat, and the current virtual world picture is switched from the world scene to the combat scene. In some embodiments, in the combat scene, there are at least two different combat behavior modes. A combat behavior mode refers to a different operation or decision-making mode in a current combat stage.

In some embodiments, the combat behavior mode includes, but is not limited to, at least one of the following:
a combat skill selection mode;
an allied pet character selection mode;
an enemy pet character capture mode;
an enemy pet character selection mode;
a prop using mode;
an escape mode; and
a group mode.

The combat skill selection mode is a mode of controlling the main control virtual character to select a skill to be cast by the allied pet character. The allied pet character selection mode is a mode of controlling the main control virtual character to select and switch an allied pet character to be used in combat. The enemy pet character capture mode is a mode of controlling the main control virtual character to capture the enemy pet character. The enemy pet character selection mode is a mode of controlling the main control virtual character to select an enemy pet character for current combat. The prop using mode is a mode of controlling the main control virtual character to select a prop to be used on the allied pet character. The escape mode is a mode of controlling the main control virtual character to end current combat and escape. The group mode is a mode of making decisions on at least two allied pet characters and at least two enemy pet characters.

In some embodiments, a player may implement a selection operation on a combat behavior mode by triggering a mode control. In some embodiments, after entering the combat scene, the terminal device displays at least one mode control on a game interface. The mode control is configured to trigger the main control virtual character or the allied pet character to enter the combat behavior mode. The mode control refers to an interface interaction element in the game interface that is configured to trigger the main control virtual character to enter the combat behavior state. In some embodiments, the mode control is usually presented in the form of an icon, a button, a text, or other forms, which is not limited in this application.

In some embodiments, the terminal device displays a mode control list on the game interface. The mode control list includes at least one mode control. The mode control list is a set including at least two mode controls. In an embodiment, the mode control list has different layouts. In some embodiments, the layout of the mode control list includes, but is not limited to, at least one of an arrangement layout, a card layout, a sliding tab layout, and a carousel layout.

Exemplarily, the layout of the mode control list is an arrangement layout, in which at least one mode control is arranged in sequence in a row or a column, or displayed in a grid form; the layout of the mode control list is a card layout, in which each mode control is displayed in the form of a card, including an icon, a name, and a brief description, each mode control is placed in a card-like container, and different mode controls have certain spacing and border therebetween, making them visually more distinct; the layout of the mode control list is a sliding tab layout, in which each mode control is displayed in the form of a sliding tab, each sliding tab represents a different type of mode control, and a user may switch between different categories of mode controls by sliding or clicking on a sliding tab; and the layout of the mode control list is a carousel layout, in which mode controls are displayed in a carousel manner, and a user may view different mode controls by sliding left or right or by automatic carousel.

In some embodiments, switching between at least two combat behavior modes is performed through a combat behavior mode selection operation. For example, through selection operations on different mode controls, switching is performed between at least two different combat behavior modes, the main control virtual character or the allied pet character is selected to enter a preset combat behavior mode, and the main control virtual character or the allied pet character is displayed as being in different combat behavior modes.

The above-mentioned selection operation on a mode control may be a touch operation on a touch screen. The present method may also be applied to a client connected to a mouse and a keyboard, or applied to a client connected to a gamepad.

Exemplarily, the selection operation on a mode control may be triggered by a touch operation on a touch screen, for example, by directly touching a mode control displayed on the game interface; or, triggered by a click operation with a mouse, for example, by directly clicking a mode control with the mouse; or, triggered by a key operation on a pre-associated numeric key on a keyboard, for example, by enabling combat behavior modes corresponding to the mode controls to be respectively associated with numeric keys 1 to 7 on the keyboard, and pressing numeric key 7 to trigger entering the escape mode; or, triggered by moving a direction joystick on a gamepad and clicking a confirmation key, for example, by moving the direction joystick upward to select a control corresponding to the escape mode, and then clicking the confirmation key to enter the escape mode, which is not limited in the embodiments of this application.

In some embodiments, in response to the combat behavior mode selection operation, the terminal device displays the target subject located in the combat scene in different display modes in different combat behavior modes. The target subject includes at least one of the main control virtual character, the allied pet character, and the enemy pet character.

In some embodiments, the display modes include at least one of an observation perspective and a control layout. In different combat behavior modes, the target subject located in the combat scene is displayed from different observation perspectives; or, in different combat behavior modes, the target subject located in the combat scene is displayed in different control layouts; or, in different combat behavior modes, the target subject located in the combat scene is displayed from different observation perspectives and in different control layouts. The observation perspective is a perspective from which a virtual camera model observes a virtual world. In some embodiments, the virtual camera model is not actually displayed in the virtual environment, that is, the camera model is not displayed in the virtual environment displayed on the game interface. The control layout refers to a visual arrangement and organization mode of interface controls (for example, buttons, information boxes, indicators, and the like) on the game interface.

In summary, in the method provided in this embodiment, in a turn-based game, by controlling the main control virtual character located in the virtual world to explore in the virtual world, after the turn-based combat trigger condition is satisfied, the virtual world exploration state is switched to the turn-based combat state, a world scene is switched to the combat scene (also referred to as a turn-based combat scene), and the allied pet character and the enemy pet character are controlled to perform turn-based combat. In the combat scene, the main control virtual character may enter different combat behavior modes. For different combat behavior modes in the combat scene, corresponding display modes of a virtual world picture are different. Each combat behavior mode has a corresponding display mode, and the target subject located in the combat scene may be displayed according to different display modes. The method of determining the display mode according to different combat behavior modes may prominently display the target subject in a current virtual world picture, helping a player focus on information with a higher current importance level.

### Display a Target Subject Located in a Combat Scene From Different Observation Perspectives

In some embodiments, in response to a combat behavior mode selection operation, a target subject located in a combat scene is displayed in different display modes in different combat behavior modes. The display modes include observation perspectives.

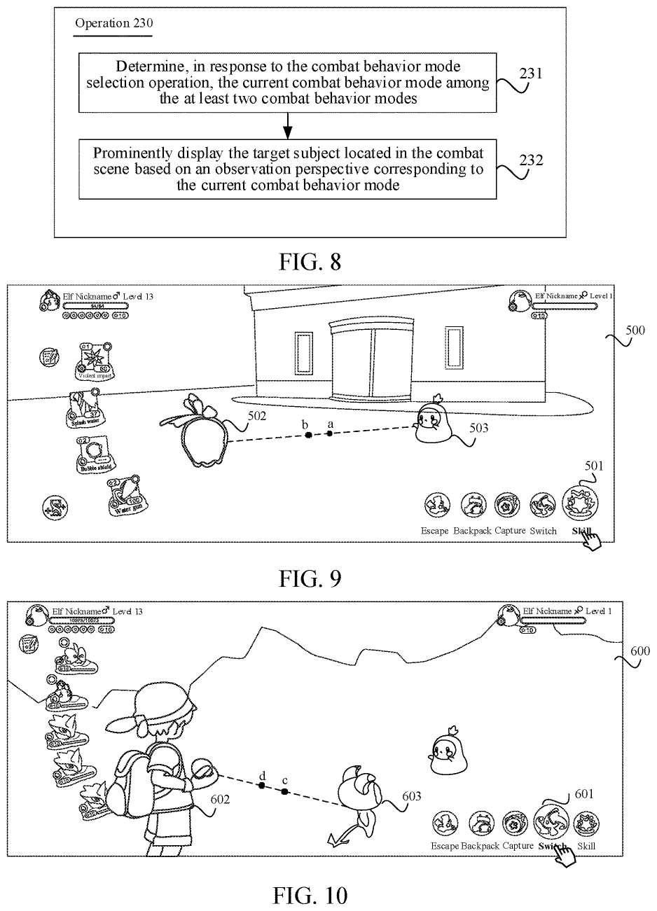

FIG. 8 is a flowchart of a method for displaying turn-based combat according to an embodiment of this application. The above operation 230 may be replaced with operation 231 and operation 232.
Operation 231: Determine, in response to a combat behavior mode selection operation, a current combat behavior mode among at least two combat behavior modes.

In some embodiments, in the combat scene, there are at least two types of different combat behavior modes. A combat behavior mode refers to a different operation or decision-making mode in a current combat stage.

In some embodiments, the combat behavior mode includes, but is not limited to, at least one of the following:
a combat skill selection mode;
an allied pet character selection mode;
an enemy pet character capture mode;
an enemy pet character selection mode;
a prop using mode;
an escape mode; and
a group mode.

The combat skill selection mode is a mode of controlling the main control virtual character to select a skill to be cast by the allied pet character. The allied pet character selection mode is a mode of controlling the main control virtual character to select and switch an allied pet character to be used in combat. The enemy pet character capture mode is a mode of controlling the main control virtual character to capture the enemy pet character. The enemy pet character selection mode is a mode of controlling the main control virtual character to select an enemy pet character for current combat. The prop using mode is a mode of controlling the main control virtual character to select a prop to be used on the allied pet character. The escape mode is a mode of controlling the main control virtual character to end current combat and escape. The group mode is a mode of making decisions on at least two allied pet characters and at least two enemy pet characters.

In some embodiments, a combat behavior mode is selected from at least two combat behavior modes to serve as the current combat behavior mode. In some embodiments, the selection operation of a combat behavior mode is performed based on a mode control, and each combat behavior mode corresponds to one mode control.

In some embodiments, the selection operation of a combat behavior mode is determined based on a selection factor. The selection factor is a reference factor for determining which combat behavior mode to be selected as the current combat behavior mode.

In some embodiments, the selection factor includes, but is not limited to, at least one of the following: an environmental factor, an attribute factor, a behavior factor, and a condition factor.

Exemplarily, the selection factor is an environmental factor, and the current combat behavior mode is determined from at least two combat behavior modes based on the environmental factor. For example, after the turn-based combat trigger condition is satisfied, the main control virtual character and the allied pet character carried for exploration in the virtual world enter the turn-based combat state. The current environment is a night environment. The allied pet character that enters the combat scene is a light-type pet character. The light-type pet character has poor combat capability in the night environment, while a dark-type pet character has enhanced vision and stronger combat capability in the night environment. In this case, switching the light-type pet character to a dark-type pet character would provide a greater combat advantage. That is, the current combat behavior mode is determined from at least two combat behavior modes as the allied pet character selection mode, which is a mode for selecting and switching an allied pet character to be used in combat.

Exemplarily, the selection factor is an attribute factor, and the current combat behavior mode is determined from at least two combat behavior modes based on the attribute factor. For example, after the turn-based combat trigger condition is satisfied, the main control virtual character and the allied pet character carried for exploration in the virtual world enter the turn-based combat state. The attribute of the allied pet character is a grass-type attribute, and the attribute of the enemy pet character is a fire-type attribute. In this case, switching the grass-type pet character to a water-type pet character would provide a greater combat advantage. That is, the current combat behavior mode is determined from at least two combat behavior modes as the allied pet character selection mode, which is a mode for selecting and switching an allied pet character to be used in combat.

Exemplarily, the selection factor is a behavior factor, and the current combat behavior mode is determined from at least two combat behavior modes based on the behavior factor. For example, after the turn-based combat trigger condition is satisfied, the main control virtual character and the allied pet character carried for exploration in the virtual world enter the turn-based combat state. In the combat scene, the enemy pet character exhibits extreme aggressive behavior and actively launches attacks on the main control virtual character and the allied pet character. In this case, the current combat behavior mode may be selected as the combat skill selection mode, so that the allied pet character directly fights the enemy pet character; or, the current combat behavior mode may be selected as the enemy pet character capture mode to directly capture the enemy pet character.

Exemplarily, the selection factor is a condition factor, and the current combat behavior mode is determined from at least two combat behavior modes based on the condition factor. For example, after the turn-based combat trigger condition is satisfied, the main control virtual character and the allied pet character carried for exploration in the virtual world enter the turn-based combat state. In the combat scene, the enemy pet character directly casts a fatal skill on the main control virtual character or the allied pet character, and the main control virtual character does not have a capture condition or a combat condition. In this case, the current combat behavior mode may be selected as the escape mode.

The above are only exemplary descriptions of the selection factors, and this application does not limit the selection factors for determining the current combat behavior mode.
Operation 232: Prominently display a target subject located in a combat scene based on an observation perspective corresponding to the current combat behavior mode.

In some embodiments, for different combat behavior modes in the combat scene, observation perspectives corresponding to different combat behavior modes are different. In some embodiments, each combat behavior mode has an observation perspective matched therewith. In some embodiments, the current combat behavior mode is determined from at least two combat behavior modes, and the target subject located in the combat scene is prominently displayed based on an observation perspective corresponding to the current combat behavior mode. The target subject includes at least one of the main control virtual character, the allied pet character, and the enemy pet character.

In some embodiments, the observation perspective is a perspective from which a virtual camera model observes a virtual world. In some embodiments, the virtual camera model is not actually displayed in the virtual environment, that is, the camera model is not displayed in the virtual environment displayed on the game interface.

In some embodiments, a terminal device displays the virtual world through the virtual world picture. The virtual world picture is a picture for observing the virtual world from an observation perspective corresponding to a virtual camera model. In some embodiments, the observation perspective determines the content that a player may see in a virtual world picture.

In the related art, an observation perspective is an angle at which a virtual camera model observes a main control virtual character in a virtual world. The observation perspective in the related art is a fixed perspective. When a first-person perspective is used, the virtual camera model is located near the head of the main control virtual character or at the head of the main control virtual character. When a third-person perspective is used, the virtual camera model may be located behind the main control virtual character and bound to the main control virtual character, or may be located at any position at a preset distance from the main control virtual character. Through the virtual camera model, the main control virtual character located in a virtual environment may be observed from different angles. In some embodiments, in addition to the first-person perspective and the third-person perspective, the perspectives also include other perspectives, such as a top-down perspective. When the top-down perspective is used, the virtual camera model may be located above the head of the main control virtual character. The top-down perspective is a perspective for observing the virtual world from a bird's-eye view. In the related art, using a fixed perspective as the observation perspective may cause a problem that a subject is not prominent in the virtual world picture.

In this embodiment of this application, for different combat behavior modes in the combat scene, observation perspectives corresponding to the virtual world picture are different. That is, the observation perspective may automatically change according to different combat behavior modes, and each combat behavior mode has an observation perspective matched therewith. A target subject located in the combat scene may be displayed according to different observation perspectives, thereby optimizing the display effect of the target subject and facilitating the player to observe the target subject located in the combat scene from different observation perspectives.

In some embodiments, the observation perspective is a perspective from which a virtual camera model observes a virtual world. In some embodiments, the terminal device first acquires a virtual reference axis of the virtual camera model, the virtual reference axis being configured for indicating a position of the target subject in the combat scene; second, determine, based on the virtual reference axis, a start point of a spring arm component, the spring arm component being a component for connecting the virtual reference axis and the virtual camera model, the start point of the spring arm component being configured for determining an orientation of the virtual camera model; then, acquire configuration content of the virtual camera model in the current combat behavior mode, and determine, according to the configuration content, a parameter of the spring arm component, the configuration content being configured for indicating a camera parameter of the virtual camera model; and finally, determine the observation perspective corresponding to the current combat behavior mode jointly based on the orientation of the virtual camera model, the parameter of the spring arm component, and the camera parameter.

The camera parameter includes at least one of: a configuration name, a target subject, a rotation angle, an offset relative to the target subject, a length relative to the target subject, a field of view, a camera depth of field, a camera position transition, and a parameter control.

In some embodiments, when an environmental variable exists in the current virtual world, the observation perspective may be changed based on the environmental variable. In some embodiments, the parameter of the spring arm component is corrected based on the environmental variable, and the changed observation perspective is determined according to the parameter of the spring arm component. In some embodiments, the camera parameter of the virtual camera model is corrected based on the environmental variable, and the changed observation perspective is determined according to the camera parameter of the virtual camera model. In some embodiments, the parameter of the spring arm component and the camera parameter of the virtual camera model are corrected based on the environmental variable, and the changed observation perspective is determined according to the parameter of the spring arm component and the camera parameter of the virtual camera model.

In some embodiments, the environmental variable includes a body size of a pet character, a terrain height at which the pet character is located, and the like. In some embodiments, the environmental variable is battlefield data acquired by the terminal device from a server at the start of turn-based combat.

In some embodiments, a player may actively adjust the observation perspective. The terminal device is provided with a touch sensor. In response to an adjustment operation on the virtual world picture, an adjustment offset for the virtual world picture is determined, and the observation perspective is changed based on the adjustment offset. In some embodiments, in response to an upward sliding operation on the virtual world picture, an upward sliding offset for the virtual world picture is determined, and the observation perspective is adjusted upward based on the upward sliding offset; in response to a downward sliding operation on the virtual world picture, a downward sliding offset for the virtual world picture is determined, and the observation perspective is adjusted downward based on the downward sliding offset; in response to a leftward sliding operation on the virtual world picture, a leftward sliding offset for the virtual world picture is determined, and the observation perspective is adjusted leftward based on the leftward sliding offset; in response to a rightward sliding operation on the virtual world picture, a rightward sliding offset for the virtual world picture is determined, and the observation perspective is adjusted rightward based on the rightward sliding offset.

By combining the orientation of the virtual camera model, the parameter of the spring arm component, and the camera parameter, the observation perspective corresponding to the current combat behavior mode is determined, ensuring the accuracy of the observation perspective and optimizing the display effect of displaying the target subject based on the observation perspective.

In summary, in the method provided in this embodiment, there are at least two combat behavior modes in the combat scene (also referred to as a turn-based combat scene), and the main control virtual character or the allied pet character may enter different combat behavior modes. For different combat behavior modes, observation perspectives corresponding to the virtual world picture are different. Each combat behavior mode has an observation perspective matched therewith, and the target subject located in the combat scene may be displayed according to different observation perspectives. This display method of determining an observation perspective according to different combat behavior modes may not only cover key regions in the combat scene but also prominently display the target subject on the current virtual world picture, ensuring that the player may observe the target subject in the current combat scene in the most intuitive manner. This real-time feedback and personalized adjustment enhance the user's immersion and operational convenience.

In some embodiments, in response to a combat behavior mode selection operation, a target subject located in a combat scene is displayed in different display modes in different combat behavior modes. In some embodiments, the display modes include an observation perspective.

The following describes, for different combat behavior modes, displaying a target subject located in a combat scene at different observation perspectives.

The current combat behavior mode is a combat skill selection mode.

The combat skill selection mode is a mode of controlling the main control virtual character to select a skill to be cast by the allied pet character.

In some embodiments, when the current combat behavior mode is the combat skill selection mode, a first target subject in the combat scene is prominently displayed based on a first observation perspective corresponding to the combat skill selection mode. The first target subject includes the allied pet character and the enemy pet character. The first observation perspective is an observation perspective in which the allied pet character is taken as a first priority object and the enemy pet character is taken as a second priority object. The first priority object and the second priority object are configured for indicating importance levels of the allied pet character and the enemy pet character, respectively, in the combat skill selection mode. In some embodiments, an importance level of the first priority object is higher than that of the second priority object.

In some embodiments, the first priority object refers to a target subject that is focused on in the first observation perspective, that is, a target subject that is preferentially displayed and emphasized in the first observation perspective. The second priority object refers to a target subject that is secondarily focused on in the first observation perspective, that is, a target subject that is displayed and emphasized in the first observation perspective in a manner subordinate to the first priority object. In some embodiments, in the combat skill selection mode, the visual priority of the allied pet character is higher than that of the enemy pet character. That is, in the first observation perspective, at least the allied pet character is taken as a primary observation perspective and the enemy pet character is taken as a secondary observation perspective.

In some embodiments, the observation perspective is determined based on a priority proportion of the target subject in the current combat behavior mode. When the target subject has priority objects with different degrees of priority, the priority proportions of the priority objects with different degrees of priority are different. The reference factor of the priority proportion includes an importance level of the target subject in the current combat behavior mode. In some embodiments, the reference factor of the priority proportion also includes an environmental variable (for example, a body size of a pet character, or a terrain height at which the pet character is located) in the virtual world picture. In some embodiments, a viewing offset degree of the observation perspective is determined by a difference in priority proportion between priority objects with different degrees of priority.

In some embodiments, in the combat skill selection mode, the allied pet character is taken as the first priority object, and the enemy pet character is taken as the second priority object. The first observation perspective is determined according to the priority proportions of the allied pet character and the enemy pet character, and the viewing offset degree of the first observation perspective is determined according to the difference in priority proportion between the allied pet character and the enemy pet character.

Exemplarily, in the combat skill selection mode, the current virtual world picture displays the allied pet character and the enemy pet character performing turn-based combat, highlighting the allied pet character casting a combat skill on the enemy pet character. In this case, the allied pet character serves as the first priority object, and the enemy pet character serves as the second priority object. For example, in this case, the priority proportion of the allied pet character is 55%, and the priority proportion of the enemy pet character is 45%. In this case, the first observation perspective is determined to be at a position slightly offset from the center between the allied pet character and the enemy pet character toward the allied pet character.

In some embodiments, the difference in priority proportion has a positive correlation with the viewing offset degree. That is, the viewing offset degree increases as the difference in priority proportion increases, and decreases as the difference in priority proportion decreases.

Exemplarily, in the combat skill selection mode, the allied pet character serves as the first priority object, and the enemy pet character serves as the second priority object. For example, in this case, the priority proportion of the allied pet character is 55%, and the priority proportion of the enemy pet character is 45%. The difference in priority proportion between the allied pet character and the enemy pet character is 10%. In this case, the first observation perspective is determined to be at a position slightly offset from the center between the allied pet character and the enemy pet character toward the allied pet character by a first offset. For another example, in this case, the priority proportion of the allied pet character is 60%, and the priority proportion of the enemy pet character is 40%. The difference in priority proportion between the allied pet character and the enemy pet character is 20%. In this case, the first observation perspective is determined to be at a position slightly offset from the center between the allied pet character and the enemy pet character toward the allied pet character by a second offset. The second offset is greater than the first offset. That is, as the priority proportion of the allied pet character increases, the importance of the first observation perspective taking the allied pet character as the primary observation perspective increases, and the position of the virtual camera model becomes more biased toward the allied pet character.

In some embodiments, the first observation perspective is a perspective from which the virtual camera model observes the virtual world in the combat skill selection mode. In some embodiments, in the combat skill selection mode, the terminal device first acquires a first virtual reference axis of the virtual camera model. In this case, the first virtual reference axis is determined by a line connecting center points of the allied pet character and the enemy pet character. After the first virtual reference axis is determined, the virtual world and the virtual camera model are connected via a spring arm component, with the first virtual reference axis as a start point and the virtual camera model as an end point. A specific position of the spring arm component on the first virtual reference axis corresponds to the viewing offset degree of the first observation perspective. In some embodiments, the start point of the spring arm component is configured for determining an orientation of the virtual camera model. Subsequently, configuration content of the virtual camera model in the combat skill selection mode is acquired, and a parameter of the spring arm component is determined according to the configuration content. The configuration content is configured for indicating a camera parameter of the virtual camera model. Finally, the first observation perspective corresponding to the combat skill selection mode is determined jointly based on the orientation of the virtual camera model, the parameter of the spring arm component, and the camera parameter.

Exemplarily, as shown in FIG. 9, a virtual world picture 500 corresponding to the combat skill selection mode is displayed. In some embodiments, a selection operation of the combat skill selection mode is performed based on a mode control. For example, based on a trigger operation on a “skill” control 501, the current combat behavior mode is determined to be the combat skill selection mode. In the combat skill selection mode, the target subjects displayed in the virtual world picture 500 are the allied pet character 502 and the enemy pet character 503. In the combat skill selection mode, the allied pet character 502 casting a combat skill on the enemy pet character 503 is highlighted. The allied pet character 502 serves as the first priority object. For example, the priority proportion of the allied pet character 502 is 55%. The enemy pet character 503 serves as the second priority object. For example, the priority proportion of the enemy pet character 503 is 45%. In this case, the first observation perspective is at a position slightly offset from the center between the allied pet character 502 and the enemy pet character 503 toward the allied pet character 502. In some embodiments, a line connecting the allied pet character 502 and the enemy pet character 503 is the first virtual reference axis, the center of the first virtual reference axis is point a, and the first observation perspective is at a position slightly offset from the center toward the allied pet character 502, that is, the first observation perspective is at point b.

In this embodiment of this application, the first observation perspective is determined by taking the allied pet character as the first priority object and the enemy pet character as the second priority object, and the position of the virtual camera model is adjusted to ensure that the target subject is displayed on the current virtual world picture in the combat skill selection mode. The first observation perspective takes the allied pet character as a primary focus and the enemy pet character as a secondary focus. This design helps the player concentrate attention on the most important allied pet character while maintaining awareness of the overall battlefield situation.

The current combat behavior mode is an allied pet character selection mode.

The allied pet character selection mode is a mode of controlling the main control virtual character to select and switch an allied pet character to be used in combat.

In some embodiments, when the current combat behavior mode is the allied pet character selection mode, a second target subject in the combat scene is prominently displayed based on a second observation perspective corresponding to the allied pet character selection mode. The second target subject includes the main control virtual character and the allied pet character. The second observation perspective is an observation perspective in which the main control virtual character is taken as a third priority object and the allied pet character is taken as a fourth priority object. The third priority object and the fourth priority object are configured for indicating importance levels of the main control virtual character and the allied pet character, respectively, in the combat skill selection mode. In some embodiments, an importance level of the third priority object is higher than that of the fourth priority object.

In some embodiments, the third priority object refers to a target subject that is focused on in the second observation perspective, that is, a target subject that is preferentially displayed and emphasized in the second observation perspective. The fourth priority object refers to a target subject that is secondarily focused on in the second observation perspective, that is, a target subject that is displayed and emphasized in the second observation perspective in a manner subordinate to the third priority object. In some embodiments, in the allied pet character selection mode, the visual priority of the main control virtual character is higher than that of the allied pet character. That is, in the second observation perspective, at least the main control virtual character is taken as a primary observation perspective and the allied pet character is taken as a secondary observation perspective.

In some embodiments, in the allied pet character selection mode, the main control virtual character is taken as the third priority object, and the allied pet character is taken as the fourth priority object. The second observation perspective is determined according to priority proportions of the main control virtual character and the allied pet character, and a viewing offset degree of the second observation perspective is determined according to a difference in priority proportion between the main control virtual character and the allied pet character.

Exemplarily, in the allied pet character selection mode, the current virtual world picture displays the main control virtual character selecting an allied pet character to perform turn-based combat, highlighting a selection operation of the main control virtual character on the allied pet character. In this case, the main control virtual character serves as the third priority object, and the allied pet character serves as the fourth priority object. For example, in this case, the priority proportion of the main control virtual character is 55%, and the priority proportion of the allied pet character is 45%. In this case, the second observation perspective is determined to be at a position slightly offset from the center between the main control virtual character and the allied pet character toward the main control virtual character.

In some embodiments, the difference in priority proportion has a positive correlation with the viewing offset degree. That is, the viewing offset degree increases as the difference in priority proportion increases, and decreases as the difference in priority proportion decreases.

Exemplarily, in the allied pet character selection mode, the main control virtual character serves as the third priority object, and the allied pet character serves as the fourth priority object. For example, in this case, the priority proportion of the main control virtual character is 55%, and the priority proportion of the allied pet character is 45%. The difference in priority proportion between the main control virtual character and the allied pet character is 10%. In this case, the second observation perspective is determined to be at a position slightly offset from the center between the main control virtual character and the allied pet character toward the main control virtual character by a first offset. For another example, in this case, the priority proportion of the main control virtual character is 60%, and the priority proportion of the allied pet character is 40%. The difference in priority proportion between the main control virtual character and the allied pet character is 20%. In this case, the second observation perspective is determined to be at a position slightly offset from the center between the main control virtual character and the allied pet character toward the main control virtual character by a second offset. The second offset is greater than the first offset. That is, as the priority proportion of the main control virtual character increases, the importance of the second observation perspective taking the main control virtual character as the primary observation perspective increases, and the position of the virtual camera model becomes more biased toward the main control virtual character.

In some embodiments, the second observation perspective is a perspective from which the virtual camera model observes the virtual world in the allied pet character selection mode. In some embodiments, in the allied pet character selection mode, the terminal device first acquires a second virtual reference axis of the virtual camera model. In this case, the second virtual reference axis is determined by a line connecting center points of the main control virtual character and the allied pet character. After the second virtual reference axis is determined, the virtual world and the virtual camera model are connected via a spring arm component, with the second virtual reference axis as a start point and the virtual camera model as an end point. A specific position of the spring arm component on the second virtual reference axis corresponds to the viewing offset degree of the second observation perspective. In some embodiments, the start point of the spring arm component is configured for determining an orientation of the virtual camera model. Subsequently, configuration content of the virtual camera model in the allied pet character selection mode is acquired, and a parameter of the spring arm component is determined according to the configuration content. The configuration content is configured for indicating a camera parameter of the virtual camera model. Finally, the second observation perspective corresponding to the allied pet character selection mode is determined jointly based on the orientation of the virtual camera model, the parameter of the spring arm component, and the camera parameter.

Exemplarily, as shown in FIG. 10, a virtual world picture 600 corresponding to the allied pet character selection mode is displayed. In some embodiments, a selection operation of the allied pet character selection mode is performed based on a mode control. For example, based on a trigger operation on a “switch” control 601, the current combat behavior mode is determined to be the allied pet character selection mode. In the allied pet character selection mode, the target subjects displayed in the virtual world picture 600 are the main control virtual character 602 and the allied pet character 603. In the allied pet character selection mode, the selection and switching operation of the main control virtual character 602 on the allied pet character 603 is highlighted. The main control virtual character 602 serves as the third priority object. For example, the priority proportion of the main control virtual character 602 is 55%. The allied pet character 603 serves as the fourth priority object. For example, the priority proportion of the allied pet character 603 is 45%. In this case, the second observation perspective is at a position slightly offset from the center between the main control virtual character 602 and the allied pet character 603 toward the main control virtual character 602. In some embodiments, a line connecting the main control virtual character 602 and the allied pet character 603 is the second virtual reference axis. The center of the second virtual reference axis is point c, and the second observation perspective is at a position slightly offset from the center toward the main control virtual character 602, that is, the second observation perspective is at point d.

In this embodiment of this application, the second observation perspective is determined by taking the main control virtual character as the third priority object and the allied pet character as the fourth priority object, and the position of the virtual camera model is adjusted to ensure that the target subject is displayed on the current virtual world picture in the allied pet character selection mode. The second observation perspective takes the main control virtual character as a primary focus and the allied pet character as a secondary focus. This design helps the player concentrate attention on the most important main control virtual character while maintaining awareness of the overall battlefield situation.

The current combat behavior mode is an enemy pet character capture mode.

The enemy pet character capture mode is a mode of controlling the main control virtual character to capture an enemy pet character.

In some embodiments, when the current combat behavior mode is the enemy pet character capture mode, a third target subject in the combat scene is prominently displayed based on a third observation perspective corresponding to the enemy pet character capture mode. The third target subject includes the main control virtual character and the enemy pet character. The third observation perspective is an observation perspective in which both the main control virtual character and the enemy pet character are taken as a fifth priority object. The fifth priority object is configured for indicating importance levels of the main control virtual character and the enemy pet character, respectively, in the enemy pet character capture mode.

In some embodiments, the fifth priority object refers to a target subject that is focused on in the third observation perspective, that is, a target subject that is preferentially displayed and emphasized in the third observation perspective. In some embodiments, in the enemy pet character capture mode, the visual priority of the main control virtual character and the visual priority of the enemy pet character are at the same priority. That is, in the third observation perspective, at least the main control virtual character and the enemy pet character are taken as primary observation perspectives.

In some embodiments, in the enemy pet character capture mode, both the main control virtual character and the enemy pet character are taken as the fifth priority object. The third observation perspective is determined according to priority proportions of the main control virtual character and the enemy pet character, and a viewing offset degree of the third observation perspective is determined according to a difference in priority proportion between the main control virtual character and the enemy pet character.

Exemplarily, in the enemy pet character capture mode, the current virtual world picture displays a capture operation of the main control virtual character on the enemy pet character. In this case, both the main control virtual character and the enemy pet character serve as the fifth priority object. For example, in this case, the priority proportion of the main control virtual character is 50%, and the priority proportion of the enemy pet character is 50%. In this case, the third observation perspective is determined to be at a center position between the main control virtual character and the enemy pet character.

In some embodiments, the third observation perspective is a perspective from which the virtual camera model observes the virtual world in the enemy pet character capture mode. In some embodiments, in the enemy pet character capture mode, the terminal device first acquires a third virtual reference axis of the virtual camera model. In this case, the third virtual reference axis is determined by a line connecting center points of the main control virtual character and the enemy pet character. After the third virtual reference axis is determined, the virtual world and the virtual camera model are connected via a spring arm component, with the third virtual reference axis as a start point and the virtual camera model as an end point. A specific position of the spring arm component on the third virtual reference axis corresponds to the viewing offset degree of the third observation perspective. In some embodiments, the start point of the spring arm component is configured for determining an orientation of the virtual camera model. Subsequently, configuration content of the virtual camera model in the enemy pet character capture mode is acquired, and a parameter of the spring arm component is determined according to the configuration content. The configuration content is configured for indicating a camera parameter of the virtual camera model. Finally, the third observation perspective corresponding to the enemy pet character capture mode is determined jointly based on the orientation of the virtual camera model, the parameter of the spring arm component, and the camera parameter.

In an embodiment, a behavior mode of a non-target subject in the combat scene may also affect the observation perspective. Exemplarily, in the enemy pet character capture mode, the target subjects in the virtual world picture corresponding to the combat scene are the main control virtual character and the enemy virtual character. In this case, the non-target subject in the virtual world picture is the allied pet character. In the enemy pet character capture mode, the allied pet character may dodge leftward, moving away from the center position of the virtual world picture, and the overall visual focus shifts from the main control virtual character to the enemy pet character, prominently displaying that the target subjects in the enemy pet character capture mode are the main control virtual character and the enemy pet character.

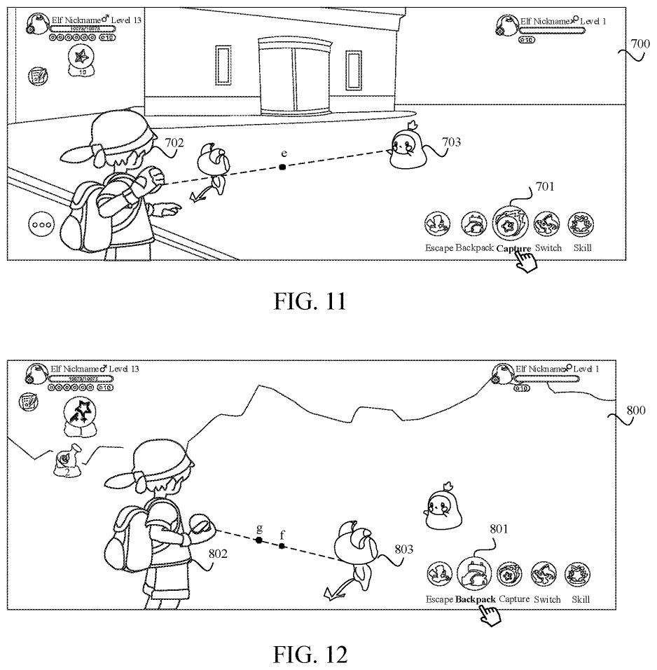

Exemplarily, as shown in FIG. 11, a virtual world picture 700 corresponding to the enemy pet character capture mode is displayed. In some embodiments, a selection operation of the enemy pet character capture mode is performed based on a mode control. For example, based on a trigger operation on a “capture” control 701, the current combat behavior mode is determined to be the enemy pet character capture mode. In the enemy pet character capture mode, the target subjects displayed in the virtual world picture 700 are the main control virtual character 702 and the enemy pet character 703. In the enemy pet character capture mode, the main control virtual character 702 and the enemy pet character 703 both serve as the fifth priority object. For example, the priority proportion of the main control virtual character 702 and the priority proportion of the enemy pet character 703 are both 50%. In this case, the third observation perspective is at a center position between the main control virtual character 702 and the enemy pet character 703. In some embodiments, a line connecting the main control virtual character 702 and the enemy pet character 703 is the third virtual reference axis. The center of the third virtual reference axis is point e, that is, the third observation perspective is at point e.

In this embodiment of this application, the second observation perspective is determined by taking the main control virtual character as the third priority object and the allied pet character as the fourth priority object, and the position of the virtual camera model is adjusted to ensure that the target subject is displayed on the current virtual world picture in the allied pet character selection mode. The second observation perspective takes the main control virtual character as a primary focus and the allied pet character as a secondary focus. This design helps the player concentrate attention on the most important main control virtual character while maintaining awareness of the overall battlefield situation.

The current combat behavior mode is a prop using mode.

The prop using mode is a mode of controlling the main control virtual character to select a prop to be used on the allied pet character.

In some embodiments, when the current combat behavior mode is the prop using mode, a fourth target subject in the combat scene is prominently displayed based on a fourth observation perspective corresponding to the prop using mode. The fourth target subject includes the main control virtual character and the allied pet character. The fourth observation perspective is an observation perspective in which the main control virtual character is taken as a sixth priority object and the allied pet character is taken as a seventh priority object. The sixth priority object and the seventh priority object are configured for indicating importance levels of the main control virtual character and the allied pet character, respectively, in the prop using mode. In some embodiments, an importance level of the sixth priority object is higher than that of the seventh priority object.

In some embodiments, the sixth priority object refers to a target subject that is focused on in the fourth observation perspective, that is, a target subject that is preferentially displayed and emphasized in the fourth observation perspective. The seventh priority object refers to a target subject that is secondarily focused on in the fourth observation perspective, that is, a target subject that is displayed and emphasized in the fourth observation perspective in a manner subordinate to the sixth priority object. In some embodiments, in the prop using mode, the visual priority of the main control virtual character is higher than that of the allied pet character. That is, in the fourth observation perspective, at least the main control virtual character is taken as a primary observation perspective and the allied pet character is taken as a secondary observation perspective.

In some embodiments, in the prop using mode, the main control virtual character is taken as the sixth priority object, and the allied pet character is taken as the seventh priority object. The fourth observation perspective is determined according to priority proportions of the main control virtual character and the allied pet character, and a viewing offset degree of the fourth observation perspective is determined according to a difference in priority proportion between the main control virtual character and the allied pet character.

Exemplarily, in the prop using mode, the current virtual world picture displays the main control virtual character selecting a prop to be used on the allied pet character, highlighting the main control virtual character applying the prop to the allied pet character. In this case, the main control virtual character serves as the sixth priority object, and the allied pet character serves as the seventh priority object. For example, in this case, the priority proportion of the main control virtual character is 55%, and the priority proportion of the allied pet character is 45%. In this case, the fourth observation perspective is determined to be at a position slightly offset from the center between the main control virtual character and the allied pet character toward the main control virtual character.

In some embodiments, the difference in priority proportion has a positive correlation with the viewing offset degree. That is, the viewing offset degree increases as the difference in priority proportion increases, and decreases as the difference in priority proportion decreases.

Exemplarily, in the prop using mode, the main control virtual character serves as the sixth priority object, and the allied pet character serves as the seventh priority object. For example, in this case, the priority proportion of the main control virtual character is 55%, and the priority proportion of the allied pet character is 45%. The difference in priority proportion between the main control virtual character and the allied pet character is 10%. In this case, the fourth observation perspective is determined to be at a position slightly offset from the center between the main control virtual character and the allied pet character toward the main control virtual character by a first offset. For another example, in this case, the priority proportion of the main control virtual character is 60%, and the priority proportion of the allied pet character is 40%. The difference in priority proportion between the main control virtual character and the allied pet character is 20%. In this case, the fourth observation perspective is determined to be at a position slightly offset from the center between the main control virtual character and the allied pet character toward the main control virtual character by a second offset. The second offset is greater than the first offset. That is, as the priority proportion of the main control virtual character increases, the importance of the fourth observation perspective taking the main control virtual character as the primary observation perspective increases, and the position of the virtual camera model becomes more biased toward the main control virtual character.

In some embodiments, the fourth observation perspective is a perspective from which the virtual camera model observes the virtual world in the prop using mode. In some embodiments, in the prop using mode, the terminal device first acquires a fourth virtual reference axis of the virtual camera model. In this case, the fourth virtual reference axis is determined by a line connecting center points of the main control virtual character and the allied pet character. After the fourth virtual reference axis is determined, the virtual world and the virtual camera model are connected via a spring arm component, with the fourth virtual reference axis as a start point and the virtual camera model as an end point. A specific position of the spring arm component on the fourth virtual reference axis corresponds to the viewing offset degree of the fourth observation perspective. In some embodiments, the start point of the spring arm component is configured for determining an orientation of the virtual camera model. Subsequently, configuration content of the virtual camera model in the prop using mode is acquired, and a parameter of the spring arm component is determined according to the configuration content. The configuration content is configured for indicating a camera parameter of the virtual camera model. Finally, the fourth observation perspective corresponding to the prop using mode is determined jointly based on the orientation of the virtual camera model, the parameter of the spring arm component, and the camera parameter.

Exemplarily, as shown in FIG. 12, a virtual world picture 800 corresponding to the prop using mode is displayed. In some embodiments, a selection operation of the prop using mode is performed based on a mode control. For example, based on a trigger operation on a “backpack” control 801, the current combat behavior mode is determined to be the prop using mode. In the prop using mode, the target subjects displayed in the virtual world picture 800 are the main control virtual character 802 and the allied pet character 803. In the prop using mode, the main control virtual character 802 selecting a prop to be used on the allied pet character 803 is highlighted. The main control virtual character 802 serves as the sixth priority object. For example, the priority proportion of the main control virtual character 802 is 55%. The allied pet character 803 serves as the seventh priority object. For example, the priority proportion of the allied pet character 803 is 45%. In this case, the fourth observation perspective is at a position slightly offset from the center between the main control virtual character 802 and the allied pet character 803 toward the main control virtual character 802. In some embodiments, a line connecting the main control virtual character 802 and the allied pet character 803 is the fourth virtual reference axis. The center of the fourth virtual reference axis is point f, and the fourth observation perspective is at a position slightly offset from the center toward the main control virtual character 802, that is, the fourth observation perspective is at point g.

In some embodiments, the prop using mode includes a secondary mode. In response to the main control virtual character being in the secondary mode, a motion posture of the main control virtual character using a target prop is zoomed in to be displayed. The secondary mode is a mode of the main control virtual character using a target prop.

In some embodiments, the target prop is a type of prop owned by the main control virtual character, and is a prop for enhancing an attribute of the allied pet character. The main control virtual character uses the target prop to improve at least one of a health point, a mana point, a defense point, an attack point, a combat speed, a combat intensity, or other combat-related attributes of the allied pet character.

In some embodiments, a manner of acquiring the target prop includes, but is not limited to, at least one of the following:
acquiring by the main control virtual character after completing a specified task;
acquiring by the main control virtual character after reaching a preset level for unlocking;
acquiring by the main control virtual character after picking up in the virtual world;
acquiring by the main control virtual character after interacting with the allied pet character;
acquiring by the main control virtual character after defeating an enemy pet character from which the prop is dropped off;
acquiring by the main control virtual character after obtaining raw materials for crafting.

In some embodiments, the target prop is a type of prop owned by the main control virtual character. For example, the target prop is a special prop that may be used only once in each turn-based combat. In some embodiments, when the main control virtual character enters the secondary mode, that is, when the main control virtual character uses the target prop to enhance the allied pet character, the current observation perspective zooms in to display a motion posture of the main control virtual character using the target prop. In some embodiments, by shortening a length of the spring arm component connecting the fourth virtual reference axis and the virtual camera model, a distance between the fourth virtual reference axis and the virtual camera model is reduced, so as to display the motion posture of the main control virtual character using the target prop at a closer range.

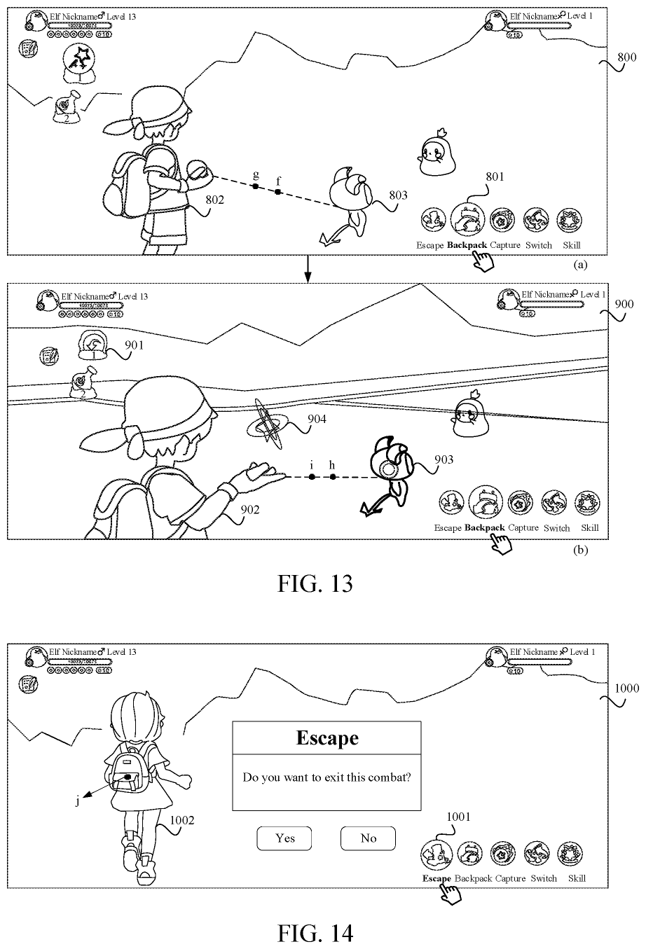

Exemplarily, as shown in part (a) of FIG. 13, a virtual world picture 800 corresponding to the prop using mode is displayed, and as shown in part (b) of FIG. 13, a virtual world picture 900 corresponding to the secondary mode is displayed. In some embodiments, in response to a trigger operation on a target prop control 901, in the secondary mode, the target subjects displayed in the virtual world picture 900 are the main control virtual character 902 and the allied pet character 903. In the secondary mode, the main control virtual character 902 using a target prop 904 to enhance the allied pet character 903 is highlighted. In the prop using mode, the fourth observation perspective is at a position slightly offset from the center between the main control virtual character 902 and the allied pet character 903 toward the main control virtual character 902. In the secondary mode corresponding to the prop using mode, the fourth observation perspective zooms in to display a motion posture of the main control virtual character 902 using the target prop 904. In this case, the fourth observation perspective is at a point i slightly offset from the center point h of the line connecting the main control virtual character 902 and the allied pet character 903 toward the main control virtual character 902. In this secondary mode, the motion posture of the main control virtual character 902 using the target prop 904 to enhance the allied pet character 903 is displayed at a close range.

In this embodiment of this application, a secondary mode exists in the prop using mode. The secondary mode is a mode in which the main control virtual character uses the target prop. When a player chooses to control the main control virtual character to use the target prop, the lens of the virtual camera model is automatically adjusted, and the lens is zoomed in to display the motion posture of the main control virtual character at a closer range, including special animations and other visual effects. By providing a close-up of the action, the sense of ritual of using the target prop is enhanced, making the player feel the importance and impact of this action.

In this embodiment of this application, the fourth observation perspective is determined by taking the main control virtual character as the sixth priority object and the allied pet character as the seventh priority object, and the position of the virtual camera model is adjusted to ensure that the target subject is displayed on the current virtual world picture in the prop using mode. The fourth observation perspective takes the main control virtual character as a primary focus and the allied pet character as a secondary focus. This design helps the player concentrate attention on the most important main control virtual character while maintaining awareness of the overall battlefield situation.

The current combat behavior mode is an escape mode.

The escape mode is a mode of controlling the main control virtual character to end a current combat and escape.

In some embodiments, when the current combat behavior mode is the escape mode, a fifth target subject in the combat scene is prominently displayed based on a fifth observation perspective corresponding to the escape mode. The fifth target subject includes the main control virtual character. The fifth observation perspective is an observation perspective in which the main control virtual character is taken as an eighth priority object.

In some embodiments, the eighth priority object refers to a target subject that is focused on in the fifth observation perspective, that is, a target subject that is preferentially displayed and emphasized in the fifth observation perspective. In some embodiments, in the fifth observation perspective corresponding to the escape mode, at least the main control virtual character is taken as a primary observation perspective.

In some embodiments, the fifth observation perspective is a perspective from which the virtual camera model observes the virtual world in the escape mode. In some embodiments, in the escape mode, the terminal device first acquires a fifth virtual reference axis of the virtual camera model. In this case, the fifth virtual reference axis is determined by the main control virtual character, that is, the fifth virtual reference axis is the main control virtual character. After the fifth virtual reference axis is determined, the virtual world and the virtual camera model are connected via a spring arm component, with the fifth virtual reference axis (in this case, the main control virtual character) as a start point and the virtual camera model as an end point. In some embodiments, the start point of the spring arm component is configured for determining an orientation of the virtual camera model. Subsequently, configuration content of the virtual camera model in the escape mode is acquired, and a parameter of the spring arm component is determined according to the configuration content. The configuration content is configured for indicating a camera parameter of the virtual camera model. Finally, the fifth observation perspective corresponding to the escape mode is determined jointly based on the orientation of the virtual camera model, the parameter of the spring arm component, and the camera parameter.

Exemplarily, as shown in FIG. 14, a virtual world picture 1000 corresponding to the escape mode is displayed. In some embodiments, a selection operation of the escape mode is performed based on a mode control. For example, based on a trigger operation on an “escape” control 1001, the current combat behavior mode is determined to be the escape mode. In the escape mode, the target subject displayed in the virtual world picture 1000 is the main control virtual character 1002. In the escape mode, the main control virtual character 1002 serves as the eighth priority object. In this case, the fifth observation perspective is at a center position of the main control virtual character 1002, that is, the fifth observation perspective is at point j.

In this embodiment of this application, the fifth observation perspective is determined by taking the main control virtual character as the eighth priority object, and the position of the virtual camera model is adjusted to ensure that the target subject is displayed on the current virtual world picture in the escape mode. The fifth observation perspective takes the main control virtual character as a primary focus. This design helps the player concentrate attention on the most important main control virtual character.

The current combat behavior mode is an enemy pet character selection mode.

The enemy pet character selection mode is a mode of controlling the main control virtual character to select an enemy pet character for a current combat. In some embodiments, the enemy pet character selection mode is one of group modes.

In some embodiments, when the current combat behavior mode is the enemy pet character selection mode, a sixth target subject in the combat scene is prominently displayed based on a sixth observation perspective corresponding to the enemy pet character selection mode. The sixth target subject includes at least two enemy pet characters. The sixth observation perspective is an observation perspective in which the at least two enemy pet characters are respectively taken as a ninth priority object. The ninth priority object is configured for indicating importance levels of the at least two enemy pet characters in the enemy pet character selection mode.

In some embodiments, the ninth priority object refers to a target subject that is focused on in the sixth observation perspective, that is, a target subject that is preferentially displayed and emphasized in the sixth observation perspective. In some embodiments, in the enemy pet character selection mode, the visual priorities of at least two enemy pet characters are at the same priority. That is, in the sixth observation perspective, at least the at least two enemy pet characters are taken as primary observation perspectives.

In some embodiments, in the enemy pet character selection mode, the at least two enemy pet characters are simultaneously taken as the ninth priority object. The sixth observation perspective is determined according to priority proportions of the at least two enemy pet characters, and a viewing offset degree of the sixth observation perspective is determined according to a difference in priority proportion between the at least two enemy pet characters.

Exemplarily, in the enemy pet character selection mode, the current virtual world picture displays at least two enemy pet characters to be selected. In this case, the at least two enemy pet characters simultaneously serve as the ninth priority object. For example, in the enemy pet character selection mode, there are two enemy pet characters, enemy pet character A and enemy pet character B, and the priority proportion of each is 50%. In this case, the sixth observation perspective is determined to be at a center position between enemy pet character A and enemy pet character B.

In some embodiments, the sixth observation perspective is a perspective from which the virtual camera model observes the virtual world in the enemy pet character selection mode. In some embodiments, in the enemy pet character selection mode, the terminal device first acquires a sixth virtual reference axis of the virtual camera model. In this case, the sixth virtual reference axis is determined by a line connecting center points of at least two enemy pet characters. After the sixth virtual reference axis is determined, the virtual world and the virtual camera model are connected via a spring arm component, with the sixth virtual reference axis as a start point and the virtual camera model as an end point. A specific position of the spring arm component on the sixth virtual reference axis corresponds to the viewing offset degree of the sixth observation perspective. In some embodiments, the start point of the spring arm component is configured for determining an orientation of the virtual camera model. Subsequently, configuration content of the virtual camera model in the enemy pet character selection mode is acquired, and a parameter of the spring arm component is determined according to the configuration content. The configuration content is configured for indicating a camera parameter of the virtual camera model. Finally, the sixth observation perspective corresponding to the enemy pet character selection mode is determined jointly based on the orientation of the virtual camera model, the parameter of the spring arm component, and the camera parameter.

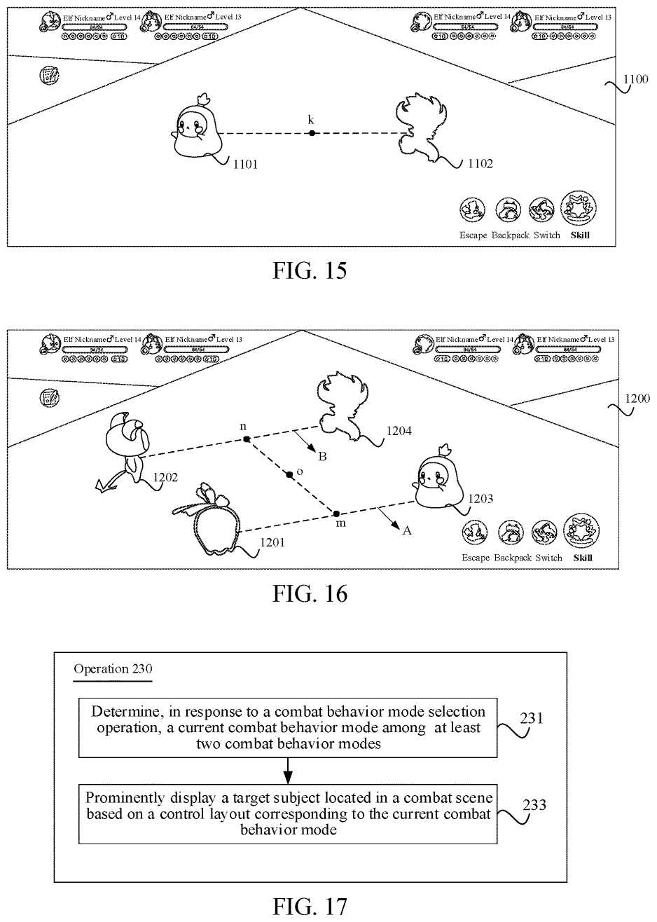

Exemplarily, as shown in FIG. 15, a virtual world picture 1100 corresponding to the enemy pet character selection mode is displayed. In the enemy pet character selection mode, the target subjects displayed in the virtual world picture 1100 are enemy pet character 1101 and enemy pet character 1102. In the enemy pet character selection mode, enemy pet character 1101 and enemy pet character 1102 both serve as the ninth priority object. For example, the priority proportion of enemy pet character 1101 is 50%, and the priority proportion of enemy pet character 1102 is 50%. In this case, the sixth observation perspective is at a center position between enemy pet character 1101 and enemy pet character 1102. In some embodiments, a line connecting enemy pet character 1101 and enemy pet character 1102 is the sixth virtual reference axis. The center of the sixth virtual reference axis is point k, that is, the sixth observation perspective is at point k.

In this embodiment of this application, the sixth observation perspective is determined by taking at least two enemy pet characters as the ninth priority object, and the position of the virtual camera model is adjusted to ensure that the target subject is displayed on the current virtual world picture in the enemy pet character selection mode. The sixth observation perspective takes the at least two enemy pet characters as a primary focus, prominently displaying the enemy pet characters to be selected. This design helps the player concentrate attention on the currently most important enemy pet characters.

### Observation Perspectives in Other Group Modes

In some embodiments, the group mode is a mode of making decisions on at least two allied pet characters and at least two enemy pet characters. In some embodiments, the group mode includes, but is not limited to, an enemy pet character selection mode, an at least two-party pet combat mode, and a combat skill selection mode for at least two allied pet characters.

When the group mode is the enemy pet character selection mode, the manner of determining the observation perspective corresponding to the enemy pet character selection mode is as described above (the sixth observation perspective).

When the group mode is the at least two-party pet combat mode, the observation perspective corresponding to the at least two-party pet combat mode is determined to prominently display target subjects in the combat scene, the target subjects being at least two allied pet characters and at least two enemy pet characters. In the at least two-party pet combat mode, the visual priorities of the at least two allied pet characters and the at least two enemy pet characters are at the same priority. In the at least two-party pet combat mode, the corresponding observation perspective is at a center position of the at least two allied pet characters and the at least two enemy pet characters.

Exemplarily, when two allied pet characters fight against two enemy pet characters, for example, allied pet character A fights against enemy pet character A, and allied pet character B fights against enemy pet character B, the target subjects in the combat scene are allied pet character A, allied pet character B, enemy pet character A, and enemy pet character B, respectively. In this case, the observation perspective corresponding to the at least two-party pet combat mode is an observation perspective determined by taking allied pet character A, allied pet character B, enemy pet character A, and enemy pet character B as equal priority objects. In some embodiments, a line connecting the center point of allied pet character A and the center point of enemy pet character A is virtual reference axis A, and a line connecting the center point of allied pet character B and the center point of enemy pet character B is virtual reference axis B. In this case, the corresponding observation perspective is at a center position obtained by connecting the center points of virtual reference axis A and virtual reference axis B.

As shown in FIG. 16, a virtual world picture 1200 corresponding to the at least two-party pet combat mode is displayed. In the at least two-party pet combat mode, allied pet character 1201 and allied pet character 1202, and enemy pet character 1203 and enemy pet character 1204 are displayed, where allied pet character 1201 fights against enemy pet character 1203, and allied pet character 1202 fights against enemy pet character 1204. For example, the priority proportion of each of allied pet character 1201, allied pet character 1202, enemy pet character 1203, and enemy pet character 1204 is 25%. In this case, the observation perspective is at a center position of allied pet character 1201, allied pet character 1202, enemy pet character 1203, and enemy pet character 1204. In some embodiments, a line connecting allied pet character 1201 and enemy pet character 1203 is virtual reference axis A, the center of virtual reference axis A is point m, a line connecting allied pet character 1202 and enemy pet character 1204 is virtual reference axis B, the center of virtual reference axis B is point n, and the center point o of the line connecting point m and point n is the observation perspective in this case.

For other multi-to-multi combat modes (for example, three allied pet characters fighting against three enemy pet characters), the observation perspective is determined in a similar manner, which will not be described in detail in this application.

When the group mode is the combat skill selection mode for at least two allied pet characters, the manner of determining the observation perspective corresponding to the combat skill selection mode for at least two allied pet characters is the same as that for the first observation perspective. That is, the at least two allied pet characters are taken as the first priority object, and the at least two enemy pet characters are taken as the second priority object, highlighting the at least two allied pet characters casting combat skills on the at least two enemy pet characters. For details, referring to the description in the relevant section of “the current combat behavior mode is a combat skill selection mode”, which will not be repeated here.

### Display a Target Subject Located in a Combat Scene in Different Control Layouts

In some embodiments, in response to a combat behavior mode selection operation, a target subject located in a combat scene is displayed in different display modes in different combat behavior modes. The display modes include control layouts.

FIG. 17 is a flowchart of a method for displaying turn-based combat according to an embodiment of this application. The above operation 230 may be replaced with operation 231 and operation 233.
Operation 231: Determine, in response to a combat behavior mode selection operation, a current combat behavior mode among at least two combat behavior modes.

In some embodiments, in the combat scene, there are at least two types of different combat behavior modes. A combat behavior mode refers to a different operation or decision-making mode in a current combat stage.

In some embodiments, the combat behavior mode includes, but is not limited to, at least one of the following:
a combat skill selection mode;
an allied pet character selection mode;
an enemy pet character capture mode;
an enemy pet character selection mode;
a prop using mode;
an escape mode; and
a group mode.

The combat skill selection mode is a mode of controlling the main control virtual character to select a skill to be cast by the allied pet character. The allied pet character selection mode is a mode of controlling the main control virtual character to select and switch an allied pet character to be used in combat. The enemy pet character capture mode is a mode of controlling the main control virtual character to capture the enemy pet character. The enemy pet character selection mode is a mode of controlling the main control virtual character to select an enemy pet character for current combat. The prop using mode is a mode of controlling the main control virtual character to select a prop to be used on the allied pet character. The escape mode is a mode of controlling the main control virtual character to end current combat and escape. The group mode is a mode of making decisions on at least two allied pet characters and at least two enemy pet characters.

In some embodiments, a combat behavior mode is selected from at least two combat behavior modes to serve as the current combat behavior mode. In some embodiments, the selection operation of a combat behavior mode is performed based on a mode control. Each combat behavior mode corresponds to one mode control.

In some embodiments, the selection operation of a combat behavior mode is determined based on a selection factor. The selection factor is a reference factor for determining which combat behavior mode to be selected as the current combat behavior mode.

In some embodiments, the selection factor includes, but is not limited to, at least one of the following: an environmental factor, an attribute factor, a behavior factor, and a condition factor.

Exemplarily, the selection factor is an environmental factor, and the current combat behavior mode is determined from at least two combat behavior modes based on the environmental factor. For example, after the turn-based combat trigger condition is satisfied, the main control virtual character and the allied pet character carried for exploration in the virtual world enter the turn-based combat state. The current environment is a night environment. The allied pet character that enters the combat scene is a light-type pet character. The light-type pet character has poor combat capability in the night environment, while a dark-type pet character has enhanced vision and stronger combat capability in the night environment. In this case, switching the light-type pet character to a dark-type pet character would provide a greater combat advantage. That is, the current combat behavior mode is determined from at least two combat behavior modes as the allied pet character selection mode, which is a mode for selecting and switching an allied pet character to be used in combat.

Exemplarily, the selection factor is an attribute factor, and the current combat behavior mode is determined from at least two combat behavior modes based on the attribute factor. For example, after the turn-based combat trigger condition is satisfied, the main control virtual character and the allied pet character carried for exploration in the virtual world enter the turn-based combat state. The attribute of the allied pet character is a grass-type attribute, and the attribute of the enemy pet character is a fire-type attribute. In this case, switching the grass-type pet character to a water-type pet character would provide a greater combat advantage. That is, the current combat behavior mode is determined from at least two combat behavior modes as the allied pet character selection mode, which is a mode for selecting and switching an allied pet character to be used in combat.

Exemplarily, the selection factor is a behavior factor, and the current combat behavior mode is determined from at least two combat behavior modes based on the behavior factor. For example, after the turn-based combat trigger condition is satisfied, the main control virtual character and the allied pet character carried for exploration in the virtual world enter the turn-based combat state. In the combat scene, the enemy pet character exhibits extreme aggressive behavior and actively launches attacks on the main control virtual character and the allied pet character. In this case, the current combat behavior mode may be selected as the combat skill selection mode, so that the allied pet character directly fights the enemy pet character; or, the current combat behavior mode may be selected as the enemy pet character capture mode to directly capture the enemy pet character.

Exemplarily, the selection factor is a condition factor, and the current combat behavior mode is determined from at least two combat behavior modes based on the condition factor. For example, after the turn-based combat trigger condition is satisfied, the main control virtual character and the allied pet character carried for exploration in the virtual world enter the turn-based combat state. In the combat scene, the enemy pet character directly casts a fatal skill on the main control virtual character or the allied pet character, and the main control virtual character does not have a capture condition or a combat condition. In this case, the current combat behavior mode may be selected as the escape mode.

The above are only exemplary descriptions of the selection factors, and this application does not limit the selection factors for determining the current combat behavior mode.
Operation 233: Prominently display a target subject located in a combat scene based on a control layout corresponding to the current combat behavior mode.

In some embodiments, for different combat behavior modes in the combat scene, control layouts corresponding to different combat behavior modes are different. In some embodiments, each combat behavior mode has a control layout matched therewith. In some embodiments, the current combat behavior mode is determined from at least two combat behavior modes, and the target subject located in the combat scene is prominently displayed based on a control layout corresponding to the current combat behavior mode. The target subject includes at least one of the main control virtual character, the allied pet character, and the enemy pet character.

In some embodiments, the control layout refers to a visual arrangement and organization manner of interface controls on a game interface. In different combat behavior modes, the control layout may adopt different layout manners. In some embodiments, the layout manners of the control layout include, but are not limited to, at least one of an arc layout, a vertical layout, a horizontal layout, a sector layout, an overlay layout, a floating button layout, a pop-up menu layout, and a custom layout. This application does not limit the layout manners of the control layout.

In some embodiments, in different combat behavior modes, interface controls are displayed in a target region in a surrounding manner around a target subject in the combat scene according to a preset layout manner. The target region is related to a display position of the target subject, the target region is a region away from a picture center relative to the target subject, and the picture center is a center position of a virtual world picture. The surrounding manner refers to interface controls being arranged around a target subject in a circle or other annular shape.

By displaying interface controls in a region away from the picture center in a surrounding manner around the target subject, on one hand, the target subject in the current combat scene may be prominently displayed by arranging the interface controls in the surrounding manner around the target subject; on the other hand, by displaying the interface controls in the region away from the picture center, the middle position of the game picture may be occupied as little as possible, ensuring the simplicity of the game interface.

In some embodiments, the target region is related to a display position of the target subject. The target region is a region away from a picture center relative to the target subject. In some embodiments, the target subject is displayed at a left position on the virtual world picture, and the target region is a left side of the target subject, that is, the interface controls are displayed on the left side of the target subject; or, the target subject is displayed at a right position on the virtual world picture, and the target region is a right side of the target subject, that is, the interface controls are displayed on the right side of the target subject; or, the target subject is displayed at an upper position on the virtual world picture, and the target region is an upper side of the target subject, that is, the interface controls are displayed on the upper side of the target subject; or, the target subject is displayed at a lower position on the virtual world picture, and the target region is a lower side of the target subject, that is, the interface controls are displayed on the lower side of the target subject. By determining the display positions of the interface controls based on the display position of the target subject, the target subject may be prominently displayed in a targeted manner, while reducing display redundancy at the center position of the game interface.

In summary, in the method provided in this embodiment of this application, there are at least two combat behavior modes in the combat scene (also referred to as a turn-based combat scene), and the main control virtual character or the allied pet character may enter different combat behavior modes. For different combat behavior modes, control layouts corresponding to the virtual world picture are different. Each combat behavior mode has a control layout matched therewith, and the target subject located in the combat scene may be displayed according to different control layouts. By adjusting the control layout according to different combat behavior modes, the interaction requirements of the player in the current combat behavior mode may be met.

In some embodiments, in response to a combat behavior mode selection operation, a target subject located in a combat scene is displayed in different display modes in different combat behavior modes. In some embodiments, the display modes include control layouts.

The following describes, for different combat behavior modes, displaying a target subject located in a combat scene at different control layouts.

The current combat behavior mode is a combat skill selection mode.

The combat skill selection mode is a mode of controlling the main control virtual character to select a skill to be cast by the allied pet character. In the combat skill selection mode, the target subject includes at least the allied pet character.

In some embodiments, when the current combat behavior mode is the combat skill selection mode, at least two first interface controls are determined based on the combat skill selection mode, and the at least two first interface controls are controlled to be arranged and displayed in a target region in a surrounding manner around the allied pet character in the combat scene. The target region is related to a display position of the allied pet character.

In some embodiments, the first interface controls are combat skill controls, and a player may select, through the first interface controls, a skill to be cast by the allied pet character in combat against an enemy pet character. In some embodiments, the constituent elements of the first interface controls include, but are not limited to, at least one of a skill button, a combat skill icon, and a skill name.

In some embodiments, in the combat skill selection mode, a first interface control list is displayed. The first interface control list includes at least two first interface controls. The at least two first interface controls may adopt different layout manners. In some embodiments, the layout manners adopted by the at least two first interface controls include, but are not limited to, at least one of an arc layout, a vertical layout, a horizontal layout, a sector layout, an overlay layout, a floating button layout, a pop-up menu layout, and a custom layout.

In some embodiments, the at least two first interface controls may be arranged and displayed in a target region in a surrounding manner around the allied pet character in the combat scene using different layout manners. The target region is a region away from a picture center relative to the allied pet character. The surrounding manner refers to the at least two first interface controls being arranged in a circle around the allied pet character. For example, the at least two first interface controls are arranged and displayed in a surrounding manner around the target subject based on an arc layout. For another example, the at least two first interface controls are arranged and displayed in a surrounding manner around the target subject based on a vertical layout.

In some embodiments, the target region is related to a display position of the allied pet character. The target region is a region away from a picture center relative to the allied pet character. In some embodiments, the allied pet character is displayed at a left position on the virtual world picture, and the target region is a left side of the allied pet character, that is, the first interface controls are displayed on the left side of the allied pet character; or, the allied pet character is displayed at a right position on the virtual world picture, and the target region is a right side of the allied pet character, that is, the first interface controls are displayed on the right side of the allied pet character; or, the allied pet character is displayed at an upper position on the virtual world picture, and the target region is an upper side of the allied pet character, that is, the first interface controls are displayed on the upper side of the allied pet character; or, the allied pet character is displayed at a lower position on the virtual world picture, and the target region is a lower side of the allied pet character, that is, the first interface controls are displayed on the lower side of the allied pet character.

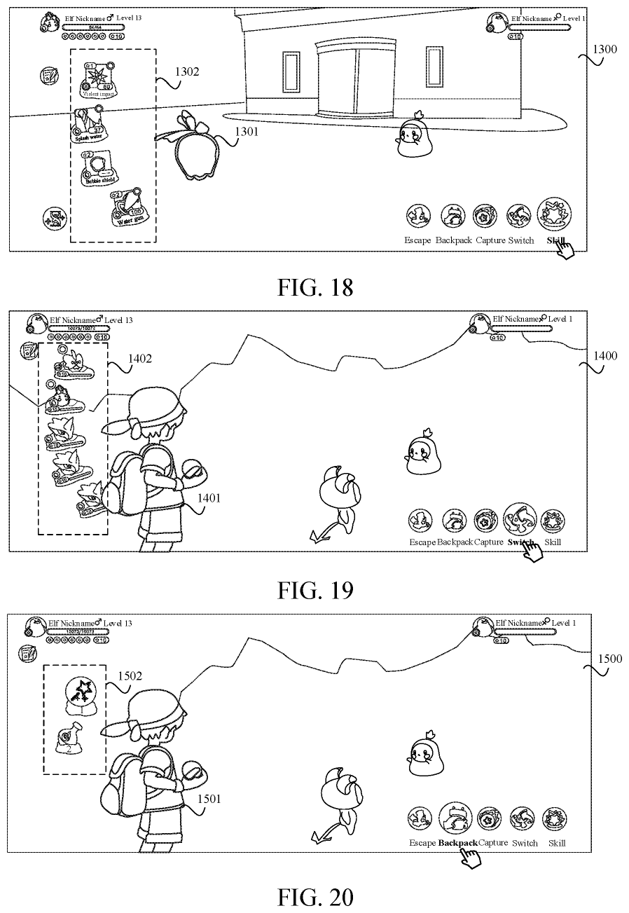

Exemplarily, as shown in FIG. 18, a virtual world picture 1300 corresponding to the combat skill selection mode is displayed. The target subject corresponding to the combat skill selection mode includes at least the allied pet character 1301. The allied pet character 1301 is displayed at a left-leaning position on the virtual world picture. At least two first interface controls 1302 are displayed in a surrounding manner around the allied pet character 1301 in the combat scene based on an arc layout, and the at least two first interface controls 1302 are displayed on the left side of the allied pet character 1301.

In this embodiment of this application, by determining the display positions of the first interface controls based on the display position of the allied pet character, the allied pet character may be prominently displayed in a targeted manner, while reducing display redundancy at the center position of the game interface.

The current combat behavior mode is an allied pet character selection mode.

The allied pet character selection mode is a mode of controlling the main control virtual character to select and switch an allied pet character to be used in combat. In the allied pet character selection mode, the target subject includes at least the main control virtual character.

In some embodiments, when the current combat behavior mode is the allied pet character selection mode, at least two second interface controls are determined based on the allied pet character selection mode, and the at least two second interface controls are controlled to be arranged and displayed in a target region in a surrounding manner around the main control virtual character in the combat scene. The target region is related to a display position of the main control virtual character.

In some embodiments, in the allied pet character selection mode, a second interface control list is displayed. The second interface control list includes at least two second interface controls. The at least two second interface controls may adopt different layout manners. In some embodiments, the layout manners adopted by the at least two second interface controls include, but are not limited to, at least one of an arc layout, a vertical layout, a horizontal layout, a sector layout, an overlay layout, a floating button layout, a pop-up menu layout, and a custom layout.

In some embodiments, the at least two second interface controls may be arranged and displayed in a target region in a surrounding manner around the main control virtual character in the combat scene using different layout manners. The target region is a region away from a picture center relative to the main control virtual character. The surrounding manner refers to the at least two second interface controls being arranged in a circle around the main control virtual character. For example, the at least two second interface controls are arranged and displayed in a surrounding manner around the target subject based on an arc layout. For another example, the at least two second interface controls are arranged and displayed in a surrounding manner around the target subject based on a vertical layout.

In some embodiments, the target region is related to a display position of the main control virtual character. The target region is a region away from a picture center relative to the main control virtual character. In some embodiments, the main control virtual character is displayed at a left position on the virtual world picture, and the target region is a left side of the main control virtual character, that is, the second interface controls are displayed on the left side of the main control virtual character; or, the main control virtual character is displayed at a right position on the virtual world picture, and the target region is a right side of the main control virtual character, that is, the second interface controls are displayed on the right side of the main control virtual character; or, the main control virtual character is displayed at an upper position on the virtual world picture, and the target region is an upper side of the main control virtual character, that is, the second interface controls are displayed on the upper side of the main control virtual character; or, the main control virtual character is displayed at a lower position on the virtual world picture, and the target region is a lower side of the main control virtual character, that is, the second interface controls are displayed on the lower side of the main control virtual character.

Exemplarily, as shown in FIG. 19, a virtual world picture 1400 corresponding to the allied pet character selection mode is displayed. The target subject corresponding to the allied pet character selection mode includes at least the main control virtual character 1401. The main control virtual character 1401 is displayed at a left-leaning position on the virtual world picture. At least two second interface controls 1402 are displayed in a surrounding manner around the main control virtual character 1401 in the combat scene based on an arc layout, and the at least two second interface controls 1402 are displayed on the left side of the main control virtual character 1401.

In this embodiment of this application, by determining the display positions of the second interface controls based on the display position of the main control virtual character, the main control virtual character may be prominently displayed in a targeted manner, while reducing display redundancy at the center position of the game interface.

The current combat behavior mode is a prop using mode.

The prop using mode is a mode of controlling the main control virtual character to select a prop to be used on the allied pet character. In the prop using mode, the target subject includes at least the main control virtual character.

In some embodiments, when the current combat behavior mode is the prop using mode, at least two third interface controls are determined based on the prop using mode, and the at least two third interface controls are controlled to be arranged and displayed in a target region in a surrounding manner around the main control virtual character in the combat scene. The target region is related to a display position of the main control virtual character.

In some embodiments, in the prop using mode, a third interface control list is displayed. The third interface control list includes at least two third interface controls. The at least two third interface controls may adopt different layout manners. In some embodiments, the layout manners adopted by the at least two third interface controls include, but are not limited to, at least one of an arc layout, a vertical layout, a horizontal layout, a sector layout, an overlay layout, a floating button layout, a pop-up menu layout, and a custom layout.

In some embodiments, the at least two third interface controls may be arranged and displayed in a target region in a surrounding manner around the main control virtual character in the combat scene using different layout manners. The target region is a region away from a picture center relative to the main control virtual character. The surrounding manner refers to the at least two third interface controls being arranged in a circle around the main control virtual character. For example, the at least two third interface controls are arranged and displayed in a surrounding manner around the target subject based on an arc layout. For another example, the at least two third interface controls are arranged and displayed in a surrounding manner around the target subject based on a vertical layout.

In some embodiments, the target region is related to a display position of the main control virtual character. The target region is a region away from a picture center relative to the main control virtual character. In some embodiments, the main control virtual character is displayed at a left position on the virtual world picture, and the target region is a left side of the main control virtual character, that is, the third interface controls are displayed on the left side of the main control virtual character; or, the main control virtual character is displayed at a right position on the virtual world picture, and the target region is a right side of the main control virtual character, that is, the third interface controls are displayed on the right side of the main control virtual character; or, the main control virtual character is displayed at an upper position on the virtual world picture, and the target region is an upper side of the main control virtual character, that is, the third interface controls are displayed on the upper side of the main control virtual character; or, the main control virtual character is displayed at a lower position on the virtual world picture, and the target region is a lower side of the main control virtual character, that is, the third interface controls are displayed on the lower side of the main control virtual character.

Exemplarily, as shown in FIG. 20, a virtual world picture 1500 corresponding to the prop using mode is displayed. The target subject corresponding to the prop using mode includes at least the main control virtual character 1501. The main control virtual character 1501 is displayed at a left-leaning position on the virtual world picture. At least two third interface controls 1502 are displayed in a surrounding manner around the main control virtual character 1501 in the combat scene based on an arc layout, and the at least two third interface controls 1502 are displayed on the left side of the main control virtual character 1501.

In this embodiment of this application, by determining the display positions of the third interface controls based on the display position of the main control virtual character, the main control virtual character may be prominently displayed in a targeted manner, while reducing display redundancy at the center position of the game interface.

In some embodiments, in response to a combat behavior mode selection operation, a target subject located in a combat scene is displayed in different display modes in different combat behavior modes. In some embodiments, the display modes include at least one of an observation perspective and a control layout.

In different combat behavior modes, the target subject located in the combat scene is displayed from different observation perspectives; or, in different combat behavior modes, the target subject located in the combat scene is displayed in different control layouts; or, in different combat behavior modes, the target subject located in the combat scene is displayed from different observation perspectives and in different control layouts.

The foregoing embodiments describe displaying, in different combat behavior modes, the target subject located in the combat scene in different observation perspectives or different control layouts, respectively. In some embodiments, in different combat behavior modes, the target subject located in the combat scene is displayed simultaneously in different observation perspectives and different control layouts. That is, the foregoing embodiments may be combined to form new embodiments.

Exemplarily, the observation perspective corresponding to the combat skill selection mode and the control layout corresponding to the combat skill selection mode are combined to form a new embodiment; or, the observation perspective corresponding to the allied pet character selection mode and the control layout corresponding to the allied pet character selection mode are combined to form a new embodiment; or, the observation perspective corresponding to the prop using mode and the control layout corresponding to the prop using mode are combined to form a new embodiment, and so on, which will not be repeated in this application.

In some embodiments, after the turn-based combat trigger condition is satisfied, the main control virtual character carries the allied pet character and switches from the world scene to the combat scene. The main control virtual character controls the allied pet character to perform turn-based combat (referred to as “combat” for short) with the enemy pet character.

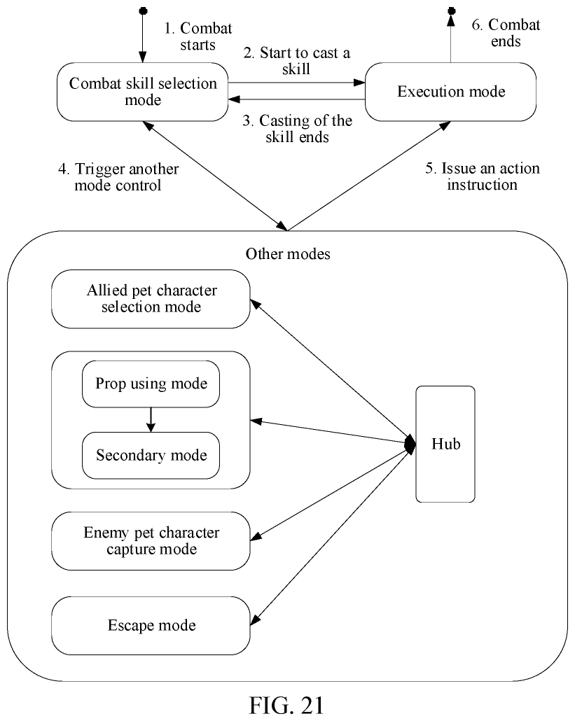

Referring to FIG. 21, it shows a schematic diagram of switching between different combat behavior modes according to an embodiment of this application. The combat behavior modes include, but are not limited to, at least one of the following: a combat skill selection mode; an allied pet character selection mode; an enemy pet character capture mode; an enemy pet character selection mode; a prop using mode; an escape mode. In some embodiments, after the combat starts, switching between different combat behavior modes is performed. The switching operations include at least one of the following:
1. Combat starts.

In some embodiments, after the combat starts, the combat skill selection mode is entered by default.
2. Start to cast a skill.

In some embodiments, after entering the combat skill selection mode, the main control virtual character may control the allied pet character to cast a combat skill.
3. Casting of the skill ends.

After the main control virtual character selects a combat skill to be used by the allied pet character in the combat, the execution mode is entered, that is, the allied pet character casts the combat skill on the enemy pet character. After the casting of the combat skill is completed, the mode returns to the combat skill selection mode, and the main control virtual character may control the allied pet character to cast a next round of combat skills.
4. The player triggers another mode control.

In some embodiments, the player may trigger another mode control, and enter another combat behavior mode by triggering the another mode control. The other combat behavior modes include at least one of the following: an allied pet character selection mode; an enemy pet character capture mode; an enemy pet character selection mode; a prop using mode; an escape mode. The prop using mode further includes a secondary mode.

In some embodiments, by triggering different mode controls, switching between different combat behavior modes may be performed.
5. Issue an action instruction.

In response to a trigger operation by the player on another mode control, that is, in response to a selection operation by the player on another combat behavior mode, an action instruction is issued to the client, that is, the current combat behavior mode is determined to be selected. For example, in response to a selection operation on an escape control, the current combat behavior mode is determined to be the escape mode, and an instruction of the escape mode is issued to the client. The client then displays a virtual world picture in the escape mode.
6. Combat ends.

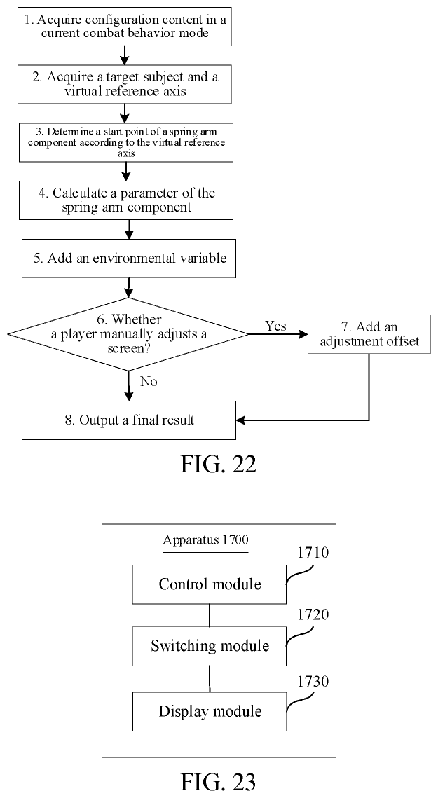

FIG. 22 shows a flowchart of a method for displaying turn-based combat according to an embodiment of this application. The execution subject of each operation of the method may be the first terminal 120 and/or the second terminal 160 and/or the third terminal 180 shown in FIG. 3, or a client that supports a virtual world and is installed on the first terminal 120 and/or the second terminal 160 and/or the third terminal 180.

In some embodiments, the operations of determining the observation perspective include at least one of the following:
Operation 1: Acquire configuration content in a current combat behavior mode.

The configuration content is configured for indicating a camera parameter of a virtual camera model. The camera parameter includes, but is not limited to, at least one of: a configuration name, a target subject, a rotation angle, an offset relative to the target subject, a length relative to the target subject, a field of view, a camera depth of field, a camera position transition, and a parameter control.

Exemplarily, the current combat behavior mode is a combat skill selection mode. In the combat skill selection mode, the configuration content corresponding to the camera parameter is as follows:

```
  {
    “Desc”: “combat skill selection mode”, // name describing the current state
    “TargetA”: 1, // allied pet character
    “TargetB”: 2, // enemy pet character
    “SpringArmRotation”: {...}, // rotation angle of the spring arm component
    “SpringArmOffset”: {...}, // offset of the spring arm component
    “SpringArmLength”: 700, // length of the spring arm component
    “Camera Fov”: 80, // field of view
    “EnableDepthOfField”: false, // whether to enable depth of field effect
    “DepthOfFieldScale”: 0, // intensity of the depth of field effect
    “CurvesArray”: [...], // curve array for adjusting camera position transition of
the virtual camera model
    “ControllerArray”: [...], // parameter control array for environmental variables
  }
```

The above-mentioned “Target” is an endpoint parameter for configuring the virtual reference axis. “Target” is configured for connecting the target subject corresponding to the virtual reference axis in the current combat behavior mode. For example, in the combat skill selection mode, the virtual reference axis is an axis for connecting the allied pet character and the enemy pet character. In this case, the two endpoints of the virtual reference axis are the allied pet character and the enemy pet character, respectively. For another example, in the enemy pet character capture mode, the virtual reference axis is an axis for connecting the main control virtual character and the enemy pet character. In this case, the two endpoints of the virtual reference axis are the main control virtual character and the enemy pet character, respectively.

In some embodiments, a Field of View (Fov) is a field of view of a virtual camera model, which determines a picture size that the virtual camera model may see. In some embodiments, as the field of view increases, the virtual camera model sees more picture content, and the frame size occupied by a single object in the picture decreases.
Operation 2: Acquire a target subject and a virtual reference axis.

In some embodiments, in different combat behavior modes, the display of the target subject in the current virtual world picture is different. The target subject is determined according to the current combat behavior mode, and the virtual reference axis is determined based on the target subject. In some embodiments, the virtual reference axis is determined by a line connecting center points of the target subjects.

Exemplarily, in the combat skill selection mode, the target subjects include the allied pet character and the enemy pet character. The virtual reference axis is determined by a line connecting the center point of the allied pet character and the center point of the enemy pet character.
Operation 3: determine a start point of a spring arm component according to the virtual reference axis.

In some embodiments, after the first virtual reference axis is determined, the virtual world and the virtual camera model are connected via the spring arm component, with the first virtual reference axis as a start point and the virtual camera model as an end point. A specific position of the spring arm component on the first virtual reference axis corresponds to the viewing offset degree of the first observation perspective. In some embodiments, the start point of the spring arm component is configured for determining an orientation of the virtual camera model.
Operation 4: Calculate a parameter of the spring arm component.

In some embodiments, the parameter of the spring arm component is calculated according to configuration content corresponding to the current combat behavior mode. The spring arm component connects the virtual world and the virtual camera model, with the first virtual reference axis as a start point and the virtual camera model as an end point.
Operation 5: Add an environmental variable.

In some embodiments, when an environmental variable exists in the current combat behavior mode, the observation perspective may be changed based on the environmental variable. In some embodiments, the parameter of the spring arm component and/or the camera parameter of the virtual camera model are corrected based on the environmental variable, and the changed observation perspective is determined according to the parameter of the spring arm component and/or the camera parameter of the virtual camera model.
Operation 6: Determine whether a player manually adjusts the screen.

In some embodiments, the player may actively adjust the observation perspective. The player manually adjusting the screen is equivalent to adjusting the observation perspective of the virtual world picture.
Operation 7: If adjusted, add an adjustment offset.

The terminal device is provided with a touch sensor. In response to an adjustment operation on the virtual world picture, an adjustment offset for the virtual world picture is determined, and the observation perspective is changed based on the adjustment offset.
Operation 8: Output a final result.

In some embodiments, the observation perspective corresponding to the current combat behavior mode is determined jointly based on the orientation of the virtual camera model, the parameter of the spring arm component, and the camera parameter.

FIG. 23 shows a structural block diagram of an apparatus for displaying turn-based combat according to an embodiment of this application. The apparatus has a function of implementing the above examples of displaying turn-based combat. The function may be implemented by hardware, or by hardware executing corresponding software. The apparatus may be the foregoing described server, or may be disposed in the server. As shown in FIG. 23, the apparatus 1700 may include: a control module 1710, a switching module 1720, and a display module 1730.

The control module 1710 is configured to control a main control virtual character to explore in a virtual world, the main control virtual character having at least one allied pet character;
the switching module 1720 is configured to switch, when a turn-based combat trigger condition is satisfied, from a virtual world exploration state to a turn-based combat state, and in the turn-based combat state, control the allied pet character to perform turn-based combat with an enemy pet character; and
the display module 1730 is configured to switch, in response to a combat behavior mode selection operation, a current combat behavior mode among at least two combat behavior modes, and displaying, in different combat behavior modes, a target subject located in a combat scene in different display modes.

The target subject includes at least one of the main control virtual character, the allied pet character, and the enemy pet character.

In some embodiments, the display module 1730 further includes a determination submodule and a display submodule.

In an embodiment, the display modes include observation perspectives;
the determination submodule is configured to determine, in response to the combat behavior mode selection operation, the current combat behavior mode among the at least two combat behavior modes; and
the display submodule is configured to prominently display the target subject located in the combat scene based on an observation perspective corresponding to the current combat behavior mode.

In some embodiments, the display submodule further includes a display unit.

In an embodiment, the current combat behavior mode is a combat skill selection mode, and the combat skill selection mode is a mode of controlling the main control virtual character to select a skill to be cast by the allied pet character; and
the display unit is configured to prominently display a first target subject in the combat scene based on a first observation perspective corresponding to the combat skill selection mode.

The first target subject includes the allied pet character and the enemy pet character, the first observation perspective is an observation perspective in which the allied pet character is taken as a first priority object and the enemy pet character is taken as a second priority object, and an importance level of the first priority object is higher than that of the second priority object.

In an embodiment, the current combat behavior mode is an allied pet character selection mode, and the allied pet character selection mode is a mode of controlling the main control virtual character to select and switch an allied pet character to be used in combat; and
the display unit is configured to prominently display a second target subject in the combat scene based on a second observation perspective corresponding to the allied pet character selection mode.

The second target subject includes the main control virtual character and the allied pet character, the second observation perspective is an observation perspective in which the main control virtual character is taken as a third priority object and the allied pet character is taken as a fourth priority object, and an importance level of the third priority object is higher than that of the fourth priority object.

In an embodiment, the current combat behavior mode is an enemy pet character capture mode, and the enemy pet character capture mode is a mode of controlling the main control virtual character to capture an enemy pet character; and
the display unit is configured to prominently display a third target subject in the combat scene based on a third observation perspective corresponding to the enemy pet character capture mode.

The third target subject includes the main control virtual character and the enemy pet character, and the third observation perspective is an observation perspective in which both the main control virtual character and the enemy pet character are taken as fifth priority objects.

In an embodiment, the current combat behavior mode is a prop using mode, and the prop using mode is a mode of controlling the main control virtual character to select a prop to be used on the allied pet character; and
the display unit is configured to prominently display a fourth target subject in the combat scene based on a fourth observation perspective corresponding to the prop using mode.

The fourth target subject includes the main control virtual character and the allied pet character, the fourth observation perspective is an observation perspective in which the main control virtual character is taken as a sixth priority object and the allied pet character is taken as a seventh priority object, and an importance level of the sixth priority object is higher than that of the seventh priority object.

In an embodiment, the prop using mode includes a secondary mode, the secondary mode is a mode of the main control virtual character using a target prop, and the target prop is a prop owned by the main control virtual character for enhancing an attribute of the allied pet character; and
the display unit is configured to zoom in to display, in response to the main control virtual character being in the secondary mode, a motion posture of the main control virtual character using the target prop.

In an embodiment, the current combat behavior mode is an escape mode, and the escape mode is a mode of controlling the main control virtual character to end a current combat and escape; and
the display unit is configured to prominently display a fifth target subject in the combat scene based on a fifth observation perspective corresponding to the escape mode.

The fifth target subject includes the main control virtual character, and the fifth observation perspective is an observation perspective in which the main control virtual character is taken as an eighth priority object.

In an embodiment, the current combat behavior mode is an enemy pet character selection mode, and the enemy pet character selection mode is a mode of controlling the main control virtual character to select an enemy pet character for a current combat; and
the display unit is configured to prominently display a sixth target subject in the combat scene based on a sixth observation perspective corresponding to the enemy pet character selection mode.

The sixth target subject includes at least two enemy pet characters, and the sixth observation perspective is an observation perspective in which the at least two enemy pet characters are taken as a ninth priority object.

In some embodiments, the apparatus 1700 further includes an acquisition module and a determination module.

In an embodiment, the observation perspective is a perspective from which a virtual camera model observes a virtual world;
the acquisition module is configured to acquire a virtual reference axis of the virtual camera model, the virtual reference axis being configured for indicating a position of the target subject in the combat scene;
the determination module is configured to determine, based on the virtual reference axis, a start point of a spring arm component, the spring arm component being a component for connecting the virtual reference axis and the virtual camera model, the start point of the spring arm component being configured for determining an orientation of the virtual camera model;
the acquisition module is configured to acquire configuration content of the virtual camera model in the current combat behavior mode, and the determination module is configured to determine, according to the configuration content, a parameter of the spring arm component, the configuration content being configured for indicating a camera parameter of the virtual camera model; and
the determination module is configured to determine the observation perspective corresponding to the current combat behavior mode jointly based on the orientation of the virtual camera model, the parameter of the spring arm component, and the camera parameter.

In an embodiment, the acquisition module is configured to acquire an environmental variable in the virtual world, and correct the observation perspective based on the environmental variable, the environmental variable being related to the parameter of the spring arm component or the camera parameter of the virtual camera model.

In an embodiment, the display modes include control layouts;
the determination submodule is configured to determine, in response to the combat behavior mode selection operation, the current combat behavior mode among the at least two combat behavior modes; and
the display submodule is configured to prominently display the target subject located in the combat scene based on a control layout corresponding to the current combat behavior mode.

In an embodiment, the current combat behavior mode is a combat skill selection mode, the combat skill selection mode is a mode of controlling the main control virtual character to select a skill to be cast by the allied pet character, and the target subject includes the allied pet character; and
the display unit is configured to determine, based on the combat skill selection mode, at least two first interface controls, and controlling the at least two first interface controls to be arranged and displayed in a target region in a surrounding manner around the allied pet character in the combat scene, the target region being related to a display position of the allied pet character.

In an embodiment, the current combat behavior mode is an allied pet character selection mode, the allied pet character selection mode is a mode of controlling the main control virtual character to select and switch an allied pet character to be used in combat, and the target subject includes the main control virtual character; and
the display unit is configured to determine, based on the allied pet character selection mode, at least two second interface controls, and controlling the at least two second interface controls to be arranged and displayed in a target region in a surrounding manner around the main control virtual character in the combat scene, the target region being related to a display position of the main control virtual character.

In an embodiment, the current combat behavior mode is a prop using mode, the prop using mode is a mode of controlling the main control virtual character to select a prop to be used on the allied pet character, and the target subject includes the main control virtual character; and
the display unit is configured to determine, based on the prop using mode, at least two third interface controls, and controlling the at least two third interface controls to be arranged and displayed in a target region in a surrounding manner around the main control virtual character in the combat scene, the target region being related to a display position of the main control virtual character.

In an embodiment, the target region is a region away from a picture center relative to the target subject, and the picture center is a center position of a virtual world picture.

In an embodiment, the target subject is displayed at a left position on the virtual world picture, and the target region is a left side of the target subject; or
the target subject is displayed at a right position on the virtual world picture, and the target region is a right side of the target subject; or
the target subject is displayed at an upper position on the virtual world picture, and the target region is an upper side of the target subject; or
the target subject is displayed at a lower position on the virtual world picture, and the target region is a lower side of the target subject.

The specific limitations in the above-provided embodiment(s) of the apparatus for displaying turn-based combat may refer to the limitations on the method for displaying turn-based combat described above, which will not be repeated here. The modules in the foregoing apparatus may be implemented entirely or partially by software, hardware, or a combination thereof. The foregoing modules may be built in or independent of a processor of a computer device in a hardware form, or may be stored in a memory of the computer device in a software form, so that the processor invokes and performs an operation corresponding to each of the foregoing modules.

The sequence numbers of the foregoing embodiments of this application are merely for description purpose but do not imply the preference among the embodiments.

An embodiment of this application further provides a computer device, the computer device including a processor and a memory, the memory having at least one computer program stored therein, the at least one computer program being loaded and executed by the processor to implement the method for displaying turn-based combat according to the method embodiments described above.

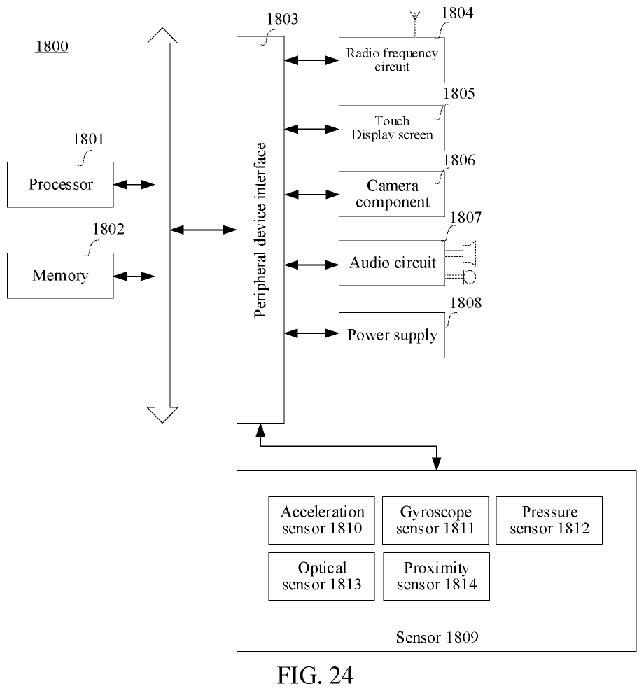

FIG. 24 shows a block diagram of a structure of a computer device 1800 according to an embodiment of this application. The computer device 1800 may be a portable mobile terminal, such as a smart phone, a tablet computer, a Moving Picture Experts Group Audio Layer III (MP3) player, or a Moving Picture Experts Group Audio Layer IV (MP4) player. The computer device 1800 may also be referred to as another name such as user equipment or portable terminal. The computer device 1800 includes a processor 1801 and a memory 1802.

The processor 1801 may include one or more processing cores, such as a 4-core processor or an 8-core processor. The processor 1801 may be implemented in at least one hardware form of a Digital Signal Processor (DSP), a Field-Programmable Gate Array (FPGA), and a Programmable Logic Array (PLA). The processor 1801 may also include a main processor and a coprocessor. The main processor is configured to process data in an active state, also referred to as a Central Processing Unit (CPU). The coprocessor is a low power consumption processor configured to process data in a standby state. In some embodiments, the processor 1801 may be integrated with a Graphics Processing Unit (GPU). The GPU is configured to render and draw content that needs to be displayed on a display screen. In some embodiments, the processor 1801 may further include an Artificial Intelligence (AI) processor. The AI processor is configured to process computing operations related to machine learning.

The memory 1802 may include one or more computer-readable storage media. The computer-readable storage media may be tangible and non-transitory. The memory 1802 may further include a high-speed random access memory and a nonvolatile memory, for example, one or more disk storage devices or flash storage devices. In some embodiments, the non-transitory computer-readable storage medium in the memory 1802 is configured to store at least one instruction, and the at least one instruction is executed by the processor 1801 to implement the method for displaying turn-based combat provided in the embodiment of this application.

In some embodiments, the computer device 1800 may further alternatively include: a peripheral interface 1803 and at least one peripheral. The processor 1801, the memory 1802, and the peripheral interface 1803 may be connected through a bus or a signal cable. Each peripheral may be connected to the peripheral interface 1803 through a bus, a signal cable, or a circuit board. Specifically, the peripheral includes at least one of a Radio Frequency (RF) circuit 1804, a touch display screen 1805, a camera component 1806, an audio circuit 1807, and a power supply 1808.

The peripheral interface 1803 may be configured to connect the at least one peripheral related to Input/Output (I/O) to the processor 1801 and the memory 1802. In some embodiments, the processor 1801, the memory 1802, and the peripheral interface 1803 are integrated on the same chip or circuit board. In some other embodiments, any one or two of the processor 1801, the memory 1802, and the peripheral interface 1803 may be implemented on an independent chip or circuit board, which is not limited in this embodiment.

The RF circuit 1804 is configured to receive and transmit an RF (Radio Frequency) signal, also referred to as an electromagnetic signal. The RF circuit 1804 communicates with a communication network and other communication devices through the electromagnetic signal. The RF circuit 1804 converts an electric signal into an electromagnetic signal for transmission, or converts a received electromagnetic signal into an electric signal. In some embodiments, the RF circuit 1804 includes an antenna system, an RF transceiver, one or more amplifiers, a tuner, an oscillator, a digital signal processor, a codec chip set, a subscriber identity module card, and the like. The RF circuit 1804 may communicate with another terminal through at least one wireless communications protocol. The wireless communication protocol includes, but is not limited to, a world wide web, a metropolitan area network, an intranet, generations of mobile communication networks (2G, 3G, 4G, and 5G), a wireless local area network and/or a wireless fidelity (Wi-Fi) network. In some embodiments, the RF circuit 1804 may further include a Near Field Communication (NFC)-related circuit, which is not limited in this application.

The touch display screen 1805 is configured to display a User Interface (UI). The UI may include a graph, text, an icon, a video, and any combination thereof. The touch display screen 1805 also has a capability of acquiring a touch signal on or above a surface of the touch display screen 1805. The touch signal may be inputted, as a control signal, into the processor 1801 for processing. The touch display screen 1805 is configured to provide a virtual button and/or a virtual keyboard, which is also referred to as a soft button and/or a soft keyboard. In some embodiments, the number of the touch display screen 1805 may be one, which is arranged on a front panel of the computer device 1800. In some other embodiments, the number of the touch display screens 1805 is at least two, which are arranged on different surfaces of the computer device 1800 respectively or in a folded design. In some embodiments, the touch display screen 1805 may be a flexible display screen, which is arranged on a curved surface or a folded surface of the computer device 1800. Even, the touch display screen 1805 may be further configured in a non-rectangular irregular pattern, that is, it is a special-shaped screen. The touch display screen 1805 may be fabricated by using a material such as Liquid Crystal Display (LCD) or Organic Light-Emitting Diode (OLED).

A camera component 1806 is configured to capture images or videos. In some embodiments, the camera assembly 1806 includes a front camera and a rear camera. The front camera is configured to implement a video call or self-portrait, and the rear camera is configured to shoot a picture or a video. In some embodiments, the number of the rear cameras is at least two, each of which is any one of a main camera, a depth of field camera, and a wide-angle camera, so as to implement a background blurring function by fusing the main camera and the depth of field camera, and panoramic shooting and Virtual Reality (VR) shooting functions by fusing the main camera and the wide-angle camera. In some embodiments, the camera assembly 1806 may further include a flashlight. The flashlight may be a single color temperature flashlight or a double color temperature flashlight. The double color temperature flashlight is a combination of a warm flashlight and a cold flashlight, and may be configured to perform light ray compensation at different color temperatures.

The audio circuit 1807 is configured to provide an audio interface between the user and the computer device 1800. The audio circuit 1807 may include a microphone and a speaker. The microphone is configured to collect a sound wave of a user and an environment, and convert the sound wave into an electrical signal and input the electrical signal to the processor 1801 for processing, or input the electrical signal to the RF circuit 1804 to achieve voice communication. For the purpose of stereo acquisition or noise reduction, there may be multiple microphones, respectively arranged at different portions of the computer device 1800. The microphone may be further an array microphone or an omnidirectional microphone. The speaker is configured to convert an electrical signal from the processor 1801 or the RF circuit 1804 into sound waves. The speaker may be a conventional thin-film speaker or a piezoelectric ceramic speaker. When the speaker is the piezoelectric ceramic speaker, the speaker may not only convert an electrical signal into sound waves audible to a human being, but also convert an electrical signal into sound waves inaudible to the human being for ranging and other purposes. In some embodiments, the audio circuit 1807 may further include an earphone jack.

The power supply 1808 is configured to supply power to each component of the computer device 1800. The power supply 1808 may be alternating current, direct current, a primary battery, or a rechargeable battery. When the power supply 1808 includes the rechargeable battery, and the rechargeable battery may be a wired rechargeable battery or a wireless rechargeable battery. The wired rechargeable battery is a battery charged through a wired cable. The wireless rechargeable battery is a battery charged through a wireless coil. The rechargeable battery may be further configured to support a fast-charging technology.

In some embodiments, the computer device 1800 further includes one or more sensors 1809. The one or more sensors 1809 include, but are not limited to an acceleration sensor 1810, a gyroscope sensor 1811, a pressure sensor 1812, an optical sensor 1813, and a proximity sensor 1814.

The acceleration sensor 1810 may detect the magnitude of acceleration on three coordinate axes of a coordinate system established with the computer device 1800. For example, the acceleration sensor 1810 may be configured to detect components of gravity acceleration on the three coordinate axes. The processor 1801 may control, according to a gravity acceleration signal acquired by the acceleration sensor 1810, the touch display screen 1805 to display the user interface in a landscape view or a portrait view. The acceleration sensor 1810 may be further configured to acquire motion data of a game or a user. The gyroscope sensor 1811 may detect a body direction and a rotation angle of the computer device 1800. The gyroscope sensor 1811 may cooperate with the acceleration sensor 1810 to acquire a 3D action by the user on the computer device 1800. The processor 1801 may implement the following functions based on the data collected by the gyroscope sensor 1811: motion sensing (such as changing the UI according to a tilt operation of the user), image stabilization at shooting, game control, and inertial navigation.

The pressure sensor 1812 may be arranged on a side frame of the computer device 1800 and/or a lower layer of the touch display screen 1805. When the pressure sensor 1812 is arranged on the side frame of the computer device 1800, a holding signal of the user on the computer device 1800 may be detected, and left and right hand recognition or a quick operation may be performed according to the holding signal. When the pressure sensor 1812 is arranged on the low layer of the touch display screen 1805, an operable control on the UI may be controlled according to a pressure operation of the user on the touch display screen 1805. The operable control includes at least one of a button control, a scroll-bar control, an icon control, and a menu control.

The optical sensor 1813 is configured to collect the ambient light intensity. In an embodiment, the processor 1801 may control display brightness of the touch display screen 1805 based on the ambient light intensity collected by the optical sensor 1813. Specifically, when the ambient light intensity is high, the display brightness of the touch display screen 1805 is increased. When the ambient light intensity is low, the display brightness of the touch display screen 1805 is adjusted down. In another embodiment, the processor 1801 may further dynamically adjust a camera parameter of the camera assembly 1806 based on the ambient light intensity collected by the optical sensor 1813.

The proximity sensor 1814, also referred to as a distance sensor, is arranged on a front surface of the computer device 1800. The proximity sensor 1814 is configured to acquire the distance between the user and the front surface of the computer device 1800. In an embodiment, when the proximity sensor 1814 detects that the distance between the user and the front surface of the computer device 1800 gradually decreases, the processor 1801 controls the touch display screen 1805 to switch from a screen-on state to a screen-off state. When the proximity sensor 1814 detects that the distance between the user and the front surface of the computer device 1800 gradually increases, the processor 1801 controls the touch display screen 1805 to switch from the screen-off state to the screen-on state.

A person skilled in the art may understand that the foregoing structure does not constitute any limitation on the computer device 1800, and the computer device may include more components or fewer components than those shown in the figure, or some components may be combined, or a different component deployment may be used.

An embodiment of this application further provides a computer-readable storage medium. The computer-readable storage medium has at least one computer program stored therein. The at least one computer program is loaded and executed by a processor to implement the method for displaying turn-based combat provided in each method embodiment described above.

An embodiment of this application further provides a computer program product. The computer program product includes at least one computer program. The at least one computer program is stored in a computer-readable storage medium. The at least one computer program is read and executed by a processor of a computer device from the computer-readable storage medium, causing the computer device to implement the method for displaying the turn-based combat provided in each method embodiment described above.

In this application, the term “module” refers to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to implement one or more modules. In addition, each module may be a part of an overall module including a function of the module. “Multiple” mentioned in the description refers to two or more. The term “and/or” describes the association relationship of associated objects, representing that there may be three relationships. For example, A and/or B may represent that A exists alone, A and B exist simultaneously, and B exists alone. The character ‘/’ represents that associated objects are in an ‘or’ relationship. In addition, the operation numbers described herein merely show a performance sequence of the operations. In some other embodiments, the operations may not be performed according to the sequence of the numbers. For example, two operations with different numbers may be performed simultaneously, or two operations with different numbers may be performed according to a sequence contrary to the sequence shown in the figure, which is not limited in the embodiments of this application.

Those skilled in the art may understand that all or some of the operations of the embodiments may be implemented by hardware, or may be implemented by a program instructing relevant hardware. The program may be stored in a computer-readable storage medium. The storage medium may be a read-only memory, a magnetic disc, an optical disc, or the like.

What are described above are merely embodiments of this application, but are not intended to limit this application. Any modification, equivalent replacement, or improvement made within the spirit and principle of this application still fall within the scope of protection of this application.

What is claimed is:

1. A method for displaying turn-based combat on a screen performed by a computer device, and the method comprising:
displaying a graphical user interface including a main control virtual character exploring in a virtual world, the main control virtual character having at least one allied pet character;
when a turn-based combat trigger condition is satisfied, switching the graphical user interface from a virtual world exploration state to a turn-based combat state, and controlling the allied pet character to perform turn-based combat with an enemy pet character in the turn-based combat state; and
in response to a combat behavior mode selection operation, switching a current combat behavior mode among at least two combat behavior modes, and displaying a target subject located in a combat scene in different display modes,
wherein the target subject comprises at least one of the main control virtual character, the allied pet character, and the enemy pet character.

2. The method according to claim 1, wherein the display modes comprise observation perspectives;
the switching a current combat behavior mode among at least two combat behavior modes, and displaying a target subject located in a combat scene in different display modes comprises:
determining, in response to the combat behavior mode selection operation, the current combat behavior mode among the at least two combat behavior modes; and
displaying the target subject located in the combat scene based on an observation perspective corresponding to the current combat behavior mode.

3. The method according to claim 2, wherein the current combat behavior mode is a combat skill selection mode, the combat skill selection mode being a mode of controlling the main control virtual character to select a skill to be cast by the allied pet character; and
the displaying the target subject located in the combat scene based on an observation perspective corresponding to the current combat behavior mode comprises:
displaying a first target subject in the combat scene based on a first observation perspective corresponding to the combat skill selection mode,
wherein the first target subject comprises the allied pet character and the enemy pet character, and the first observation perspective is an observation perspective in which the allied pet character is taken as a first priority object and the enemy pet character is taken as a second priority object, an importance level of the first priority object being higher than that of the second priority object.

4. The method according to claim 2, wherein the current combat behavior mode is an allied pet character selection mode, the allied pet character selection mode being a mode of controlling the main control virtual character to select and switch an allied pet character to be used in combat; and
the displaying the target subject located in the combat scene based on an observation perspective corresponding to the current combat behavior mode comprises:
displaying a second target subject in the combat scene based on a second observation perspective corresponding to the allied pet character selection mode,
wherein the second target subject comprises the main control virtual character and the allied pet character, and the second observation perspective is an observation perspective in which the main control virtual character is taken as a third priority object and the allied pet character is taken as a fourth priority object, an importance level of the third priority object being higher than that of the fourth priority object.

5. The method according to claim 2, wherein the current combat behavior mode is an enemy pet character capture mode, the enemy pet character capture mode being a mode of controlling the main control virtual character to capture the enemy pet character; and
the displaying the target subject located in the combat scene based on an observation perspective corresponding to the current combat behavior mode comprises:
displaying a third target subject in the combat scene based on a third observation perspective corresponding to the enemy pet character capture mode,
wherein the third target subject comprises the main control virtual character and the enemy pet character, and the third observation perspective is an observation perspective in which both the main control virtual character and the enemy pet character are taken as fifth priority objects.

6. The method according to claim 2, wherein the current combat behavior mode is a prop using mode, the prop using mode being a mode of controlling the main control virtual character to select a prop to be used on the allied pet character; and
the displaying the target subject located in the combat scene based on an observation perspective corresponding to the current combat behavior mode comprises:
displaying a fourth target subject in the combat scene based on a fourth observation perspective corresponding to the prop using mode,
wherein the fourth target subject comprises the main control virtual character and the allied pet character, and the fourth observation perspective is an observation perspective in which the main control virtual character is taken as a sixth priority object and the allied pet character is taken as a seventh priority object, an importance level of the sixth priority object being higher than that of the seventh priority object.

7. The method according to claim 2, wherein the current combat behavior mode is an escape mode, the escape mode being a mode of controlling the main control virtual character to end current combat and escape; and
the displaying the target subject located in the combat scene based on an observation perspective corresponding to the current combat behavior mode comprises:
displaying a fifth target subject in the combat scene based on a fifth observation perspective corresponding to the escape mode,
wherein the fifth target subject comprises the main control virtual character, and the fifth observation perspective is an observation perspective in which the main control virtual character is taken as an eighth priority object.

8. The method according to claim 2, wherein the current combat behavior mode is an enemy pet character selection mode, the enemy pet character selection mode being a mode of controlling the main control virtual character to select an enemy pet character for current combat; and
the displaying the target subject located in the combat scene based on an observation perspective corresponding to the current combat behavior mode comprises:
displaying a sixth target subject in the combat scene based on a sixth observation perspective corresponding to the enemy pet character selection mode,
wherein the sixth target subject comprises at least two enemy pet characters, and the sixth observation perspective is an observation perspective in which the at least two enemy pet characters are taken as a ninth priority object.

9. The method according to claim 2, wherein the observation perspective is a perspective from which a virtual camera model observes a virtual world, and the method further comprises:
acquiring a virtual reference axis of the virtual camera model, the virtual reference axis being configured for indicating a position of the target subject in the combat scene;
determining, based on the virtual reference axis, a start point of a spring arm component, the spring arm component being a component for connecting the virtual reference axis and the virtual camera model, the start point of the spring arm component being configured for determining an orientation of the virtual camera model;
acquiring configuration content of the virtual camera model in the current combat behavior mode, and determining, according to the configuration content, a parameter of the spring arm component, the configuration content being configured for indicating a camera parameter of the virtual camera model; and
determining the observation perspective corresponding to the current combat behavior mode jointly based on the orientation of the virtual camera model, the parameter of the spring arm component, and the camera parameter.

10. The method according to claim 1, wherein the display modes comprise control layouts; and
the switching a current combat behavior mode among at least two combat behavior modes, and displaying a target subject located in a combat scene in different display modes comprises:
determining, in response to the combat behavior mode selection operation, the current combat behavior mode among the at least two combat behavior modes; and
displaying the target subject located in the combat scene based on a control layout corresponding to the current combat behavior mode.

11. A computer device, comprising: a processor and a memory, the memory having at least one computer program stored therein, the at least one computer program, when executed by the processor, causing the computer device to implement a method for displaying turn-based combat on a screen including:
displaying a graphical user interface including a main control virtual character exploring in a virtual world, the main control virtual character having at least one allied pet character;
when a turn-based combat trigger condition is satisfied, switching the graphical user interface from a virtual world exploration state to a turn-based combat state, and controlling the allied pet character to perform turn-based combat with an enemy pet character in the turn-based combat state; and
in response to a combat behavior mode selection operation, switching a current combat behavior mode among at least two combat behavior modes, and displaying a target subject located in a combat scene in different display modes,
wherein the target subject comprises at least one of the main control virtual character, the allied pet character, and the enemy pet character.

12. The computer device according to claim 11, wherein the display modes comprise observation perspectives;
the switching a current combat behavior mode among at least two combat behavior modes, and displaying a target subject located in a combat scene in different display modes comprises:
determining, in response to the combat behavior mode selection operation, the current combat behavior mode among the at least two combat behavior modes; and
displaying the target subject located in the combat scene based on an observation perspective corresponding to the current combat behavior mode.

13. The computer device according to claim 12, wherein the current combat behavior mode is a combat skill selection mode, the combat skill selection mode being a mode of controlling the main control virtual character to select a skill to be cast by the allied pet character; and
the displaying the target subject located in the combat scene based on an observation perspective corresponding to the current combat behavior mode comprises:
displaying a first target subject in the combat scene based on a first observation perspective corresponding to the combat skill selection mode,
wherein the first target subject comprises the allied pet character and the enemy pet character, and the first observation perspective is an observation perspective in which the allied pet character is taken as a first priority object and the enemy pet character is taken as a second priority object, an importance level of the first priority object being higher than that of the second priority object.

14. The computer device according to claim 12, wherein the current combat behavior mode is an allied pet character selection mode, the allied pet character selection mode being a mode of controlling the main control virtual character to select and switch an allied pet character to be used in combat; and
the displaying the target subject located in the combat scene based on an observation perspective corresponding to the current combat behavior mode comprises:
displaying a second target subject in the combat scene based on a second observation perspective corresponding to the allied pet character selection mode,
wherein the second target subject comprises the main control virtual character and the allied pet character, and the second observation perspective is an observation perspective in which the main control virtual character is taken as a third priority object and the allied pet character is taken as a fourth priority object, an importance level of the third priority object being higher than that of the fourth priority object.

15. The computer device according to claim 12, wherein the current combat behavior mode is an enemy pet character capture mode, the enemy pet character capture mode being a mode of controlling the main control virtual character to capture the enemy pet character; and
the displaying the target subject located in the combat scene based on an observation perspective corresponding to the current combat behavior mode comprises:
displaying a third target subject in the combat scene based on a third observation perspective corresponding to the enemy pet character capture mode,
wherein the third target subject comprises the main control virtual character and the enemy pet character, and the third observation perspective is an observation perspective in which both the main control virtual character and the enemy pet character are taken as fifth priority objects.

16. The computer device according to claim 12, wherein the current combat behavior mode is a prop using mode, the prop using mode being a mode of controlling the main control virtual character to select a prop to be used on the allied pet character; and
the displaying the target subject located in the combat scene based on an observation perspective corresponding to the current combat behavior mode comprises:
displaying a fourth target subject in the combat scene based on a fourth observation perspective corresponding to the prop using mode,
wherein the fourth target subject comprises the main control virtual character and the allied pet character, and the fourth observation perspective is an observation perspective in which the main control virtual character is taken as a sixth priority object and the allied pet character is taken as a seventh priority object, an importance level of the sixth priority object being higher than that of the seventh priority object.

17. The computer device according to claim 12, wherein the current combat behavior mode is an escape mode, the escape mode being a mode of controlling the main control virtual character to end current combat and escape; and
the displaying the target subject located in the combat scene based on an observation perspective corresponding to the current combat behavior mode comprises:
displaying a fifth target subject in the combat scene based on a fifth observation perspective corresponding to the escape mode,
wherein the fifth target subject comprises the main control virtual character, and the fifth observation perspective is an observation perspective in which the main control virtual character is taken as an eighth priority object.

18. The computer device according to claim 12, wherein the current combat behavior mode is an enemy pet character selection mode, the enemy pet character selection mode being a mode of controlling the main control virtual character to select an enemy pet character for current combat; and
the displaying the target subject located in the combat scene based on an observation perspective corresponding to the current combat behavior mode comprises:
displaying a sixth target subject in the combat scene based on a sixth observation perspective corresponding to the enemy pet character selection mode,
wherein the sixth target subject comprises at least two enemy pet characters, and the sixth observation perspective is an observation perspective in which the at least two enemy pet characters are taken as a ninth priority object.

19. The computer device according to claim 12, wherein the observation perspective is a perspective from which a virtual camera model observes a virtual world, and the method further comprises:
acquiring a virtual reference axis of the virtual camera model, the virtual reference axis being configured for indicating a position of the target subject in the combat scene;
determining, based on the virtual reference axis, a start point of a spring arm component, the spring arm component being a component for connecting the virtual reference axis and the virtual camera model, the start point of the spring arm component being configured for determining an orientation of the virtual camera model;
acquiring configuration content of the virtual camera model in the current combat behavior mode, and determining, according to the configuration content, a parameter of the spring arm component, the configuration content being configured for indicating a camera parameter of the virtual camera model; and
determining the observation perspective corresponding to the current combat behavior mode jointly based on the orientation of the virtual camera model, the parameter of the spring arm component, and the camera parameter.

20. A non-transitory computer storage medium having at least one computer program stored therein, the at least one computer program, when executed by a processor of a computer device, causing the computer device to implement a method for displaying turn-based combat on a screen including:
displaying a graphical user interface including a main control virtual character exploring in a virtual world, the main control virtual character having at least one allied pet character;
when a turn-based combat trigger condition is satisfied, switching the graphical user interface from a virtual world exploration state to a turn-based combat state, and controlling the allied pet character to perform turn-based combat with an enemy pet character in the turn-based combat state; and
in response to a combat behavior mode selection operation, switching a current combat behavior mode among at least two combat behavior modes, and displaying a target subject located in a combat scene in different display modes,
wherein the target subject comprises at least one of the main control virtual character, the allied pet character, and the enemy pet character.
